(19) United States
(12) Patent Application Publication
(10) Pub. No.: US 2012/0325695 A1
(43) Pub. Date: Dec. 27, 2012

(54) MAGNETIC STORAGE DEVICE

(75) Inventors: Thomas P. Schein, Appleton, WI (US); Brent J. Grinwald, Appleton, WI (US)

(73) Assignee: All About Packaging Inc., Appleton, WI (US)

(21) Appl. No.: 13/602,306

(22) Filed: Sep. 3, 2012

Related U.S. Application Data
(63) Continuation-in-part of application No. 12/930,324, filed on Jan. 3, 2011, now Pat. No. 8,256,618.
(60) Provisional application No. 61/401,402, filed on Aug. 11, 2010.

(51) Int. Cl. H01F 7/20; B65D 85/00

(52) U.S. Cl. 206/216; 335/285

(57) ABSTRACT

A magnetic storage device for an article has a magnet that cooperates with a protuberance, cavity or recess to resist movement of the article.

### CROSS-REFERENCE TO RELATED PATENT APPLICATIONS

The present continuation-in-part application claims priority under 35 USC Section 120 from co-pending U.S. patent application filed on Jan. 3, 2011 by Thomas P. Schein and Brent J. Grinwald and entitled MAGNETIC STORAGE DEVICE AND A METHOD OF ASSEMBLING THE DEVICE which claims priority from U.S. Provisional Application 61/401, 402 filed on Aug. 11, 2010, the full disclosures both of which are hereby incorporated by reference.

### BACKGROUND

Magnetic storage devices are sometimes utilized to store articles or article having a magnetic affinity. Such storage devices may be difficult and complex to manufacture, may not be suited for all types of articles and may not provide intuitive removal of articles from the storage device or attachment of articles to the storage device.

### BRIEF DESCRIPTION OF THE DRAWINGS

FIG. 1 is a perspective view of a magnetic storage device capable of retaining a plurality of articles each having a magnetic affinity.

FIG. 2 is a cross-sectional view of the magnetic storage device shown in FIG. 1 taken along line 2-2.

FIG. 3 is a cross-sectional view of an alternative embodiment of the magnetic storage device shown in FIG. 1.

FIG. 4 is a perspective view of an elongated magnet having a rectangular cross-section.

FIG. 5 is a front view of another embodiment of a magnetic storage device.

FIG. 6 is a right side view of the magnetic storage device shown in FIG. 5.

FIG. 7 is a perspective view of the magnetic storage device shown in FIG. 5.

FIG. 8 is a cross-sectional view of the magnetic storage device taken along line 8-8 of FIG. 9 is an exploded view of the magnetic storage device shown in FIG. 5.

FIG. 10 is a perspective view of four magnetic storage devices connected together and with each device retaining batteries of a different size.

FIG. 11 is a perspective view of still another embodiment of a magnetic storage device which is capable of retaining a plurality of different size articles.

FIG. 12 is a perspective view of an example base unit of a magnetic storage device.

FIG. 13 is a perspective view of an example magnetic storage device.

FIG. 14 is a perspective view of an example magnetic storage device.

FIG. 15 is a perspective view of an example magnetic storage device.

FIG. 16 is a perspective view of an example magnetic storage device.

FIG. 17 is a perspective view of an example magnetic storage device.

FIG. 18 is a perspective view of an example magnetic storage device.

FIG. 19 is a perspective view of an example magnetic storage device.

FIG. 20 is a perspective view of an example magnetic storage device.

FIG. 21 is a perspective view of an example magnetic storage device.

FIG. 22 is a perspective view of an example magnetic storage device in an opened state.

FIG. 23 is a perspective view of the magnetic storage device of claim 22 in a closed state.

FIG. 24 is a perspective view of an example magnetic storage device in an opened state.

FIG. 25 is a perspective view of the magnetic storage device of claim 24 in a closed state.

FIG. 26 is a perspective view of an example magnetic storage device in an opened state.

FIG. 27 is a perspective view of the magnetic storage device of claim 26 in a closed state.

FIG. 28 is a perspective view of an example magnetic storage device in an opened state.

FIG. 29 is a perspective view of the magnetic storage device of claim 28 in a closed state.

FIG. 30 is a perspective view of an example magnetic storage device.

FIG. 31 is a perspective view of an example magnetic storage device.

FIG. 32 is a perspective view of an example magnetic storage device.

FIG. 33 is a perspective view of an example magnetic storage device.

FIG. 34 is a perspective view of an example magnetic storage device.

FIG. 35 is a perspective view of an example magnetic storage device.

FIG. six is a perspective view of an example magnetic storage device.

FIG. 37 is a perspective view of an example magnetic storage device.

FIG. 38 is a perspective view of an example magnetic storage device.

FIG. 39 is a perspective view of an example magnetic storage device.

FIG. 40 is a perspective view of an example magnetic storage device.

FIG. 41 is a perspective view of an example magnetic storage device.

FIG. 42 is a perspective view of an example magnetic storage device.

FIG. 43 is a perspective view of an example magnetic storage device.

FIG. 44 is a perspective view of an example magnetic storage device.

FIG. 45 is a perspective view of an example magnetic storage device.

FIG. 46 is a perspective view of an example magnetic storage device.

FIG. 47 is a perspective view of an example magnetic storage device.

FIG. 48 is a perspective view of an example magnetic storage device.

FIG. 49 is a perspective view of an example magnetic storage device.

FIG. 50 is a perspective view of an example magnetic storage device storing articles.

FIG. 51 is a perspective view of the magnetic storage device of FIG. 50 omitting articles.

FIG. 52 is an exploded perspective view of the magnetic storage device of FIG. 51.

FIG. 53 is a sectional view of the magnetic storage device of FIG. 51 taken along line 53-53.

FIG. 54 is a perspective view of an example magnetic storage device in an opened state in containing articles.

FIG. 55 is an exploded perspective view of the magnetic storage device and articles of FIG. 54.

FIG. 56 is a perspective view of the magnetic storage device of FIG. 54 in a horizontal orientation and in a closed state.

FIG. 57 is a perspective view of the magnetic storage device of FIG. 54 in a vertical orientation and in an opened state.

FIG. 58 is a first perspective view of an example magnetic storage device.

FIG. 59 is a second perspective view of the magnetic storage device of FIG. 57.

FIG. 60 is a front view of the magnetic storage device of FIG. 58.

FIG. 61 is a top view of the magnetic storage device of FIG. 58.

FIG. 62 is a rear side view of the magnetic storage device of FIG. 58.

FIG. 63 is an exploded perspective view of the magnetic storage device of FIG. 58.

FIG. 64 is a sectional view of the magnetic storage device of FIG. 58.

### DETAILED DESCRIPTION OF THE EXAMPLE EMBODIMENTS

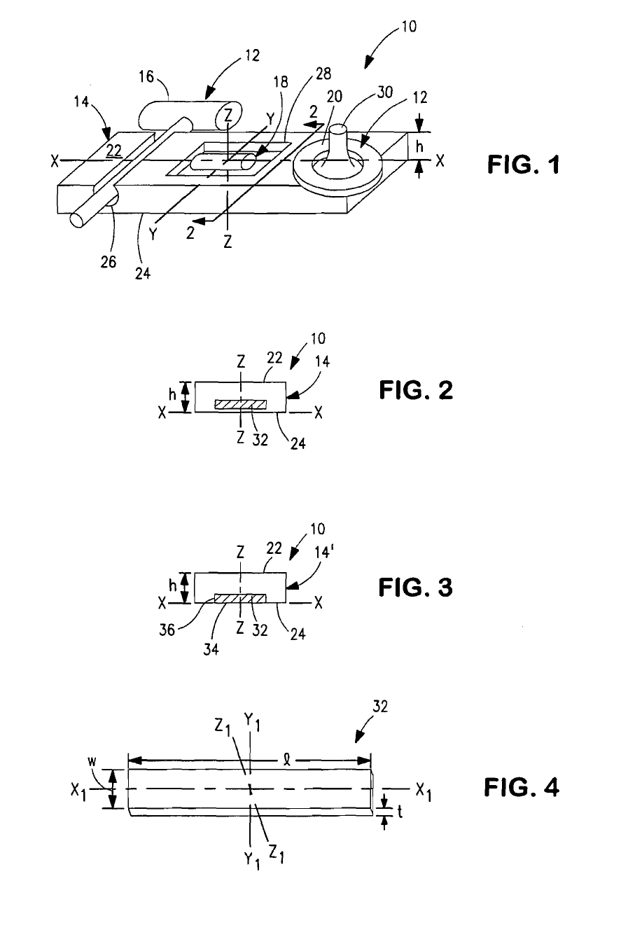

Referring to FIG. 1, a magnetic storage device 10 is shown which is capable of retaining at least one article 12, and desirably a plurality of articles 12, each having a thickness and a magnetic affinity. By “article” it is meant an individual thing or element of a class; a particular item. For example, the article 12 could be a tool, including but not limited to, a wrench, a socket, a socket head which can be connected to a socket wrench, a drill, a drill bit, a screwdriver, a screwdriver bit, a pair of pliers, a tool having a stem, shank or handle, or any other kind of tool. In addition, the article 12 could be a kitchen utensil, a battery, a key, a medal, a small part, a sporting goods such as hunting and fishing accessories, a bullet, a shotgun shell, a fishing lure, a fishing hook, a fishing fly, etc. The article 12 could also be an item needed for a particular hobby; an item associated with a particular activity or interest; an item needed to perform one's professional job, such as medical or dental instruments; an item needed to make or repair equipment such as jewelry components; a figurine such as toy metal soldiers; tie clips; bow ties or any item that includes a metal or iron part, or contain a metal coating. Furthermore, the article 12 could be any of various hardware items such as: a metal fastener, a metal stud, a cylindrical metal bar, a washer, a nut, a bolt, a screw, a pin, a nail, etc. Those skilled in the art will be aware that the article 12 can be almost any item created by man.

The magnetic storage device 10 includes a three-dimensional (3D) tray 14 with a longitudinal central axis X-X, a transverse central axis Y-Y and a vertical central axis Z-Z. The tray 14 is capable of holding or retaining one or more of the articles 12. Desirably, the tray 14 can retain a plurality of articles 12. Each of the articles 12 can be identical, similar or different in size, shape, type, kind and/or construction. In FIG. 1, three articles 12 are depicted, each of which varies in size, shape and kind The left most article 12 is a hammer 16; the central article 12 is a cylindrical pin 18; and the right most article 12 is a washer 20.

Typically, one or more articles 12 will be packaged in the magnetic storage device 10. Desirably, two or more articles 12 will be packaged in the magnetic storage device 10. Even more desirably, several articles 12 will be packaged in the magnetic storage device 10. Most desirably, a plurality of articles 12 will be packaged in the magnetic storage device 10. The actual number of articles 12 retained, housed or stored in the magnetic storage device 12 can vary from one article to many articles. In some instances, the magnetic storage device 10 can hold a dozen or more articles 12, and in some instances, the magnetic storage device 10 can hold over a hundred small articles 12 depending upon the size and configuration of the particular articles 12.

The articles 12 can be formed, molded, manufactured, assembled and/or constructed such that at least a portion of each article 12 is formed from or contains a metal, such as iron or a metal oxide. Each article 12 could also contain a ferric or ferrous substance, include ferrous oxide or some other metal oxide, or be ferromagnetic. By “ferric” it is meant of or relating to, or containing iron, especially with a valence of 3 or a valence higher than in a corresponding ferrous compound. By “ferrous” it is meant of or relating to, or containing iron, especially with a valence of 2 or a valence lower than in a corresponding ferric compound. Alternatively, a portion of the outer periphery of an article 12 can contain a metal coating. Still further, a metal chip could be partially or fully inserted into each article 12 so that it has an affinity to a magnet.

Each article 12 has a magnetic affinity. By “magnetic affinity” it is meant the article 12 has a natural attraction to a magnet or magnetic member or magnetic substance. Each of the articles 12 can have a magnetically attractive portion or surface. Desirably, each of the articles 12 is constructed partially or totally out of metal or steel, or includes a metal chip, or contains a metal coating. The amount of metal from which each of the articles 12 is formed, or the amount of metal inserted into each of the articles 12, or the amount of metal coated onto each of the articles 12 can vary. Desirably, each article 12 has a metal content that is equal to at least about 5% of the article's total weight. When a metal coating is utilized which is sprayed, brushed, coated or somehow adhered to at least a portion of the outer periphery of the article 12, the actual amount of metal present can be even less than about 5% of the article's total weight. For example, the metal coating may constitute only about 3% of the article's total weight. Desirably, the amount of metal contained in each of the articles 12 or the amount of metal coating adhered to each of the articles 12 will range from between about 3% to about 100% of the article's total weight. More desirably, the amount of metal contained in each of the articles 12 or the amount of metal coating adhered to the articles will range from between about 5% to about 100%. Even more desirably, the amount of metal contained in of each of the articles 12 or the amount of metal coating adhered to the articles will range from between about 10% to about 100%.

When the article 12 is a tool, such as a wrench, the article 12 can contain from about 25% to about 100% metal. Desirably, when the article 12 is a tool, the article 12 can contain from about 50% to about 100% metal. More desirably, when the article 12 is a tool, the article 12 can contain from about 75% to about 100% metal.

Still referring to FIG. 1, the tray 14 can be formed using various processes known to those skilled in the art. Injection molding and thermoforming are two common methods that can be employed to construct the magnetic storage device 10. The magnetic storage device 10 can be constructed from one or more materials. Such material(s) include but are not limited to: a plastic such as a polyolefin, polyethylene, polypropylene or a combination thereof; a thermoplastic; a clear plastic; a transparent plastic; a colored plastic; stamped sheet metal; a metal or a metal alloy; aluminum or an aluminum alloy; wood; glass; fiberglass; plywood; paper; paperboard; cardboard; veneer; a composite material; a fabric; a leather; etc. Desirably, a portion of the magnetic storage device 10 is constructed from a clear or transparent material, such as plastic, so that the article 12 retained therein is visible to the naked eye.

Alternatively, the magnetic storage device 10 could be made from a single material embedded with a permanent magnet or a permanent magnetic powder. The material would likely be considered a binder, such as an epoxy. The combination of magnetic material and binder could be molded, machined or die-pressed into a desired shape.

Still referring to FIG. 1, the tray 14 has an upper surface 22, a lower surface 24 and a height h therebetween. The overall geometrical configuration of the tray 14 can vary. Likewise, the height h can vary in dimension. Desirably, the height h of the tray 14 is at least about 0.25 inches. More desirably, the height h of the tray 14 is at least about 0.5 inches. Even more desirably, the height h of the tray 14 is at least about 0.75 inches. The tray 14 can have a height h that ranges from between about 0.25 inches to about 12 inches. Desirably, the tray 14 has a height h which ranges from between about 0.3 inches to about 3 inches. Even more desirably, the tray 14 has a height h which ranges from between about 0.4 inches to about 2 inches.

The upper surface 22 of the tray 14 can be flat, planar, curved or arcuate, or be irregular in profile. The upper surface 22 can be completely flat or have one or more indentations, cavities, depressions, channels, etc. extending downward therefrom. The upper surface 22 can also have one or more humps, bumps, protuberances, extensions, etc. extending upward therefrom. The one or more indentations, cavities, depressions, channels, etc. and/or the one or more humps, bumps, protuberances, extensions, etc. can function to influence the position, alignment and/or spatial orientation of each of the articles 12 on the tray 14. The primary functions of the indentations, cavities, depressions, channels, humps, bumps, protuberances and extensions is to limit the movement of each of the articles 12 and to orient or establish the position of each of the articles 12 on the tray 14. The indentations, cavities, depressions, channels, humps, protuberances and extensions limit the movement of the articles 12 in one or more directions. The articles 12 can be positioned and retained in a set orientation relative to the X-X, Y-Y and Z-Z axes.

The articles 12 can be spaced away from the lower surface 24 by any desired distance. Any single indentation, cavity, depression, channel, hump, bump, protuberance or extension can be designed to influence the position and specific orientation of one or more of the articles 12 such that their magnetic affinity is aligned in a predetermined direction. Likewise, multiple indentations, cavities, depressions, channels, humps, bumps, protuberances or extensions can be designed to influence the position and specific orientation of a single article 12.

The one or more indentations, cavities, depressions, channels, etc. and/or the one or more humps, bumps, protuberances, extensions, etc. can also immobilize each of the articles 12 in an orderly and organized manner. In FIG. 1, a semi-circular, elongated channel 26 is depicted formed in the upper surface 22 into which the handle of the hammer 16 is retained. The upper surface 22 also has a rectangularly shaped cavity 28 for retaining the cylindrical pin 18, and a conical protuberance 30 for retaining the washer 20. The outer perimeter of the upper surface 22 can be of any desired geometrical shape.

The lower surface 24 of the tray 14 is relatively flat or planar although it could be somewhat irregular, if desired. The lower surface 24 can also be slightly concave or convex. The lower surface 24 could also be textured, if desired. Desirably, the lower surface 24 is relatively flat so that it can rest against another flat surface. The outer perimeter of the lower surface 24 can be of any desired geometrical shape. The outer perimeter of the lower surface 24 can be identical, similar or different in size and/or shape from the outer periphery of the upper surface 22. The lower surface 24 is designed to contact and be magnetically attracted to a metal member. The metal member can be a stationary or movable member. The metal member should be at least partially constructed from a ferric or ferrous substance, such as a metal or steel, and have a magnetic affinity. The metal member can be any one of various items including but not limited to: a metal storage cabinet; a steel cabinet, a metal appliance, such as a door or a side of a refrigerator; a tool box; a wheeled tool cart; a tool chest; a sliding drawer constructed from metal; a vehicle fender, outer body or bumper, such as the outer surface of a car, truck, van, bus, motorcycle, etc.; a metal post; a metal beam; etc.

Referring now to FIG. 2, the magnetic storage device 10 also includes a magnetic member 32. The magnetic member 32 can include one or more permanent magnets. The magnetic member 32 is also a 3-dimensional (3-D) member that can vary in size, shape, type and kind The magnetic member 32 can be a single magnet or a series of magnet segments. In FIG. 2, the magnetic member 32 is shown as a single, elongated magnet having a rectangular cross-sectional configuration. The magnetic member 32 is completely enclosed and embedded in the tray 14 and is positioned or aligned closer to the lower surface 24 than to the upper surface 22. However, the magnetic member 32 could be spaced an equal distance from the upper and lower surfaces, 22 and 24 respectively, or be positioned closer to the upper surface 22, if desired. Desirably, the magnetic member 32 is located closer to the lower surface 24 so that it exerts a sufficient magnetic affinity for attaching the magnetic storage device 10 to a metal member (not shown) when it is brought into close contact with the metal member. By attaching the lower surface 24 of the tray 14 to the metal member, the upper surface 22 and the articles 12 positioned thereon or therein will be readily accessible.

The magnetic member 32 can be fully enclosed in the tray 14 by forming the tray 14 from two or more sections. There are a variety of possible embodiments where two or more sections are used to enclose or surround the magnetic member 32. One way to visualize these embodiments is to picture a shell surrounding the magnetic member 32. The shell can be divided many different ways. For example, the shell can be divided into top and bottom members, left and right members, major and minor members, etc. The two or more sections can be assembled around the magnetic member 32 and fastened to one another in a variety of ways, including but not limited to: using a press fit, a snap fit, using molded-in-threads (helix threads), fasteners such as screws, pins, rivets, using solvent bonding, adhesive bonding, ultrasonic welding, vibration welding, spin welding, electromagnetic welding, induction welding, hot platen or hot plate welding, staking, brazing, soldering, crimping, sewing, etc.

Referring now to FIG. 3, an alternative embodiment of a magnetic storage device 10′ is depicted. In the magnetic storage device 10′, the magnetic member 32 is aligned flush with the lower surface 24 of the tray 14′ and exhibits an exposed surface 34. In other words, the magnetic member 32 is not completely embedded in the tray 14′. In this embodiment, the exposed surface 34 of the magnetic member 32 can be aligned flush with the lower surface 24, be slightly raised above the lower surface 24, or extend slightly below the lower surface 24. Desirably, the exposed surface 34 of the magnetic member 32 is aligned flush with the lower surface 24 of the tray 14′. This configuration will allow the lower surface 24 of the tray 14′ to be attached flush with a metal member, such as the fender on an automobile (not shown). There are various ways of fastening the magnetic member 32 to the tray 14′. For example, a recess 36 can be formed in the lower surface 24 of the tray 14′. The magnetic member 32 can be inserted or be positioned in the recess 36. Various mechanical fasteners or an adhesive can be used to secure the magnetic member 32 in the recess 36. For example, one could use a press fit, a snap fit, use an over molding technique, mold-in-threads (helix threads), use screws, pins, rivets, etc., use solvent bonding, adhesive bonding, ultrasonic welding, vibration welding, spin welding, electromagnetic welding, induction welding, hot platen or hot plate welding, staking, brazing, soldering, crimping, sewing or other means known to those skilled in the art.

Alternatively, the lower surface 24 of the tray 14′ can contain a recess 36 which surrounds the magnetic member 32 and a base (not shown) can be secured to the tray 14′ so as to enclose the recess 36.

Turning now to FIG. 4, one example of a magnetic member 32 is depicted. The magnetic member 32 can be a flexible magnet or a non-flexible magnet. The magnetic member 32 can have any desired geometrical configuration but for explanation purposes only, it will be described as an elongated strip of magnetic material having a longitudinal central axis X₁-X₁, a transverse central axis Y₁-Y₁, and a vertical central axis Z₁-Z₁. The magnetic member 32 has a length 1 measured parallel to the longitudinal central axis X₁-X₁. The length 1 of the magnetic member 32 can vary. When the magnetic member 32 is a single elongated strip, it should have a length 1 of at least about 1 inch, desirably, at least about 2 inches, and more desirably, at least about 3 inches. The length 1 of the magnetic member 32 can vary depending upon the size of the magnetic storage device 10 or 10′ that it is associated with. Normally, the length 1 of the magnetic member 32 will increase as the overall length of the magnetic storage device 10 or 10′ increases.

The magnetic member 32 also has a width w which can also vary. The width w of the magnetic member 32 can range from between about 0.1 inches to about 2 inches. Desirably, the width w of the magnetic member 32 ranges from between about 0.2 inches to about 1.5 inches. More desirably, the width w of the magnetic member 32 ranges from between about 0.3 inches to about 1.25 inches. Furthermore, the magnetic member 32 has a thickness t which can vary as well. The thickness t of the magnetic member 32 can range from between about 0.01 inches to about 0.5 inches. Desirably, the thickness t of the magnetic member 32 ranges from between about 0.05 inches to about 0.3 inches. More desirably, the thickness t of the magnetic member 32 ranges from between about 0.1 inches to about 0.25 inches.

The magnetic member 32 can be purchased from a variety of commercial vendors. One such company that sells magnets is Bunting Magnetic Company of Newton, Kans. The magnetic member 32 can be formed from any suitable magnet material, including ceramic, metallic and flexible magnetic materials. The magnetic member 32 can be a discrete ceramic or ferrite elements in a discoidal or substantially rectangular shape. Alternatively, the magnetic member 32 can be cut from a magnetic sheet into a smaller shape and size. Multiple smaller magnetic members can be cut to form a series of discrete magnets.

The magnetic member 32 can also be formed from a homogeneous material which is magnetized with one pole along one surface and an opposite pole along an opposite surface to form north-south regions. Likewise, the magnetic member 32 can be formed from a conventional flexible magnet of the sort having magnetizable barium ferrite particles dispersed in a rubbery matrix. Such materials are available from Arnold Engineering Company and RJF International Corporation. The magnetic member 32 can further be formed from a suitable powdered metallic material such as iron oxide.

The magnetic member 32 can be held in place in any suitable manner. For example, the magnetic member 32 can be secured to the tray 14 or 14′ by glue, an adhesive, by an epoxy, by a silicone adhesive, by a cyanoacrylate adhesive, or by some other adhesive known to those skilled in the adhesive art. Alternatively, the magnetic member 32 could be inserted into the recess 36 and be held in place by a tight, friction or interference fit. Still further, the magnetic member 32 could be secured to the tray 14 or 14′ by a mechanical device or be secured using a tongue and groove structure.

The magnetic member 32 can produce a magnetic flux. The magnetic flux serves two purposes. First, the magnetic flux will attract and secure the lower surface 24 of the tray 14 or 14′ to a metal member (not shown). The magnetic flux is of sufficient force that the magnetic storage device 10 or 10′ will resist movement relative to the metal member. Second, the magnetic flux will hold each of the articles 12 in position adjacent to the upper surface 22 of the tray 14 or 14′, or in one of the indentations, cavities, depressions, channels, or on one of the humps, bumps, protuberances or extensions. When the articles 12 are positioned or placed within one of the indentations, cavities, depressions, channels, or on one of the humps, bumps, protuberances, extensions, the user of the magnetic storage device 10 or 10′ will have to exert a slight force in order to remove each of the articles 12 from its original position. The magnetic flux insures that vibration, bumping or jarring of the magnetic storage device 10 or 10′ will not cause the articles 12 to dislodge from the respective indentations, cavities, depressions or channels, or from the humps, bumps, protuberances or extensions. The magnetic flux also assures that each of the articles 12 can be removed from the magnetic storage device 10 or 10′ without disturbing the position of the magnetic storage device 10 or 10′ relative to the metal member.

The magnetic flux is not so strong that it prevents or hinders a person, such as a mechanic, in removing and/or replacing an article 12 from and then back into the magnetic storage device 10 or 10′. Desirably, a person should be able to remove or replace an article 12 using only one hand. The magnetic storage device 10 or 10′ facilitates the utilization of a set of tools, i.e. socket wrench heads, especially when the mechanic is in an awkward position such that a one-handed operation is essential. Likewise, the magnetic flux is not so strong that it prevents or hinders a person from removing the magnetic storage device 10 or 10′ from the metal member.

The magnetic member 32 exerts a sufficient magnetic attraction on the articles 12 when each is positioned on the upper surface 22, or is placed in one of the indentations, cavities, depressions or channels, or is placed on one of the humps, bumps, protuberances or extensions. This magnetic attraction will temporarily retain the articles 12 therein. The magnetic member 32 exerts a sufficient magnetic attraction such that the articles 12 will be retained on the upper surface 22, or in one of the indentations, cavities, depressions or channels, or on one of the humps, bumps, protuberances or extensions even when the magnetic storage device 10 or 10′ is placed at a steep angle, for example, at 90 degrees to the ground or floor, or is inverted (turned upside down).

As stated above, the magnetic member 32 also simultaneously exerts a sufficient magnetic flux or attraction through the lower surface 24 or through its exposed surface 34 to releasably attach the magnetic storage device 10 or 10′ to a metal member. The magnetic member 32 will secure the magnetic storage device 10 or 10′ to any ferrous metallic surface, such as a metallic work bench or shelf, a motor vehicle, or any other suitable location. For example, the magnetic storage device 10 or 10′ can be used by a mechanic working in the engine compartment of a motor vehicle. The magnetic storage device 10 or 10′ can be magnetically attached to any portion of the metal surface of the vehicle. The orientation of the magnetic storage device 10 or 10′ is not important since it can be attached to a metal surface of the vehicle even while inverted or on its side. The placement of the magnetic storage device 10 or 10′ close to the area being worked upon increases the efficiency of the mechanic and generally makes the job a lot easier.

There may also be times when a mechanic does not know the exact diameter of a particular socket wrench head which is needed to fit onto the head of a bolt, which is to be removed or tightened. In this situation, the mechanic will try to match up a socket wrench head to test the size of the bolt. The mechanic may have to try two or three socket wrench heads before he finds the correct diameter. Having the magnetic storage device 10 or 10′ located adjacent to his work area will make this whole process quicker and more efficient. The mechanic will not be required to reach for another socket wrench head which may be located several feet away.

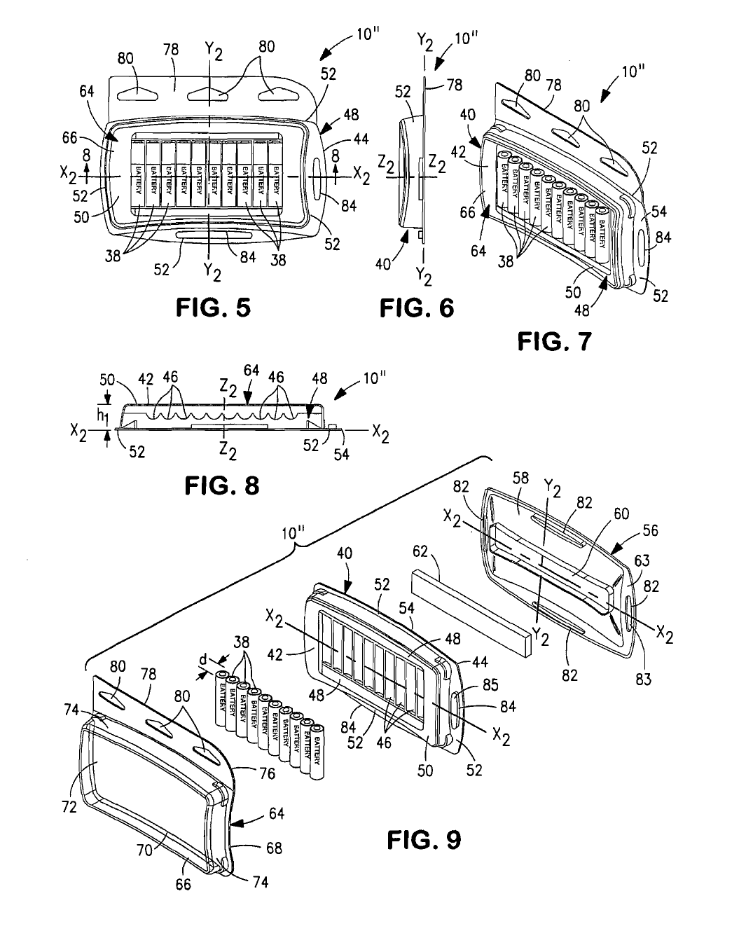

Referring now to FIGS. 5-9, another embodiment of a magnetic storage device 10″ is depicted. This magnetic storage device 10′″ is specifically designed to house and retain a plurality of batteries 38. However, the magnetic storage device 10″ could retain or house different articles 12 as well. The batteries 38 are depicted as all being of the same size. However, two or more different size batteries 38 could be retained or housed in the magnetic storage device 10′″, if desired. The exact number of batteries 38 retained in the magnetic storage device 10″ can vary from 1 to about 50 or more. In FIGS. 5-7, ten batteries 38 are shown and each is of the same size. The batteries 38 can vary in actual size. For example, the batteries can be AAA, AA, A, C, D, or any other size that is commercially manufactured.

The magnetic storage device 10″ has a longitudinal central axis X₂-X₂, a transverse central axis Y₂-Y₂, and a vertical central axis Z₂-Z₂. The magnetic storage device 10″ includes a three dimensional (3D) tray 40 having an upper surface 42, a lower surface 44 and a height h₁ therebetween. The tray 40 has one or more cavities 46 formed therein. Desirably, the tray 40 has two or more cavities 46 formed therein. More desirably, the tray 40 has a plurality of cavities 46 formed therein. Ten cavities are depicted in FIG. 5, with each cavity 46 being sized and configured to receive at least a portion of a battery 38. Each battery 38 has a thickness or diameter d, see FIG. 9. As mentioned above, the battery 38 could be any other article having a predetermined thickness. If the battery 38 does not have an elongated, cylindrical shape with a measurable diameter, then the thickness of the battery 38 can be used. For example, a smoke detector uses a rectangularly shaped battery having a thickness of about ⅜ of an inch.

The plurality of cavities 46 formed in the tray 40 can be of any desired geometrical shape. As depicted, each of the plurality of cavities 46 has an elongated, semi-circular configuration with opposite ends. Multiple cavities 46 form an undulating surface having a scallop appearance. The opposite ends of each of the plurality of cavities 46 can be at least partially surrounded by a pair of raised abutments 48, 48. The pair of raised abutments 48, 48 is shown being located at opposite ends of each of the semi-circular cavities 46. Alternatively, one could utilize a single raised abutment 48 which is located at one end of each of the semi-circular cavities 46.

The pair of raised abutments 48, 48 are spaced apart and aligned parallel to one another. Each of the pair of raised abutments 48, 48 is located adjacent to an end of each of the plurality of cavities 46. Each of the pair of raised abutments 48, 48 has an upper surface 50, 50. The upper surface 50 of each of the pair of raised abutments 48, 48 can vary in configuration. For example, the upper surface 50 can be planar, concave, convex, irregular, curved, etc. The upper surface 50 can also vary in height along its length. Desirably, the height of the upper surfaces 50, 50 will be constant throughout their lengths. The upper surface 50 of each of the pair of raised abutments 48, 48 is located below the upper surface 42 of the tray 40. The upper surface 50 of each of the pair of abutments 48, 48 is positioned above the lowest point of each of the plurality of cavities 46. The upper surface 50 of each of the pair of abutments 48, 48 extends upward to a height that is less than half of the thickness or diameter of one of the batteries 38 positioned in one of the plurality of cavities 46.

The upper surface 50 of each of the pair of abutments 48, 48 can have a height that intersects the thickness or diameter of each of the batteries 38 such that from about 1% to about 50% of the thickness or diameter of each battery 38 is at or below the upper surface 50. Another way of stating this is to say that less than about 50% of the thickness or diameter of each battery 38 is positioned in one of the plurality of cavities 46. Desirably, less than about 45% of the thickness or diameter of each battery 38 is positioned in one of the plurality of cavities 46. More desirably, less than about 40% of the thickness or diameter of each battery 38 is positioned in one of the plurality of cavities 46. Even more desirably, less than about 35% of the thickness or diameter of each battery 38 is positioned in one of the plurality of cavities 46. Most desirably, less than about 30% of the thickness or diameter of each battery 38 is positioned in one of the plurality of cavities 46. The reason for this size difference is to allow a person to easily retrieve a battery 38 from the tray 40. By limiting the height of the pair of abutments 48, 48, one can quickly and readily remove each of the batteries 38 from their respective cavities 46 or return a battery to a cavity 46.

The magnetic storage device 10″ further includes a nesting, overlapping or locking feature which enables one magnetic storage device 10″ to be positioned adjacent to or be conterminously aligned with another like magnetic storage device 10″. This feature can be accomplished several ways. One way is to construct the tray 40 with a flange 52. The flange 52 terminates into an outer periphery 54. The flange 52 can extend horizontally outward to the outer periphery 54, see FIG. 8. The flange 52 can extend outward from a portion of the tray 40 or from the entire tray 40. In other words, the flange 52 can extend outward a full 360 degrees or only extend outward a portion thereof. In FIG. 5, the flange 52 extends outward beyond the entire upper surface 42 of the tray 40. The length or extent that the flange 52 extends outward from the outline of the upper surface 42 of the tray 40 can vary. Alternatively, the length or extent that the flange 52 extends outward from the outline of the upper surface 42 of the tray 40 can be a constant. In other words, the flange 52 would extend outward the same amount from all points of the outline of the upper surface 42 of the tray 40. In FIG. 5, the flange 52 extends outward from the right side and the bottom of the outline of the upper surface 42 of the tray 40 to a greater extent than it does on the left side. However, one can choose in what direction one wishes the flange 52 to extend outward from the outline of the upper surface 42 of the tray 40. The flange 52 can extend outward from the entire outline of the upper surface 42 of the tray 40 an equal amount. Likewise, one can manufacture the tray 40 such that the flange 52 extends outward different amounts from the various sides of the tray 40. The size, shape, and/or geometrical configuration of the flange 52 can also vary. Furthermore, the flange 52 can vary in thickness. The thickness of the flange 52 is measured parallel to the vertical central axis Z₂-Z₂.

The amount the flange 52 extends outward from the outer periphery 54 of the tray 40 can vary from between about 0.05 inches to about 1 inch or more. Desirably, the flange 52 extends outward from the outline of the upper surface 42 of the tray 40 from between about 0.1 inches to about 0.75 inches. The flange 52 can extend outward parallel to the longitudinal central axis X-X and/or parallel to the transverse central axis Y-Y.

Referring now to FIG. 9, the magnetic storage device 10″ also includes a base 56 having an upper surface 58 and a cavity 60 formed in the upper surface 58. The upper surface 58 can be contoured, if desired. The upper surface 58 of the base 56 is sized and configured to mate or nest with the lower surface 44 of the tray 40. Alternatively, the base 56 can be sized and configured so that it can be adhesively bonded, mechanically attached, secured by an interference fit, a friction fit, or otherwise be secured to the tray 40 by means known to those skilled in the art.

The cavity 60 formed in the base 56 can vary in size; shape and location. Desirably, the cavity 60 is an elongated opening that extends downwardly from the upper surface 58 and has a longitudinal axis which is aligned parallel with the longitudinal axis X.sub.2-X.sub.2. The cavity 60 is designed to receive, partially or fully, a magnetic member 62. The magnetic member 62 can be similar to the magnetic member 32, explained above with reference to FIG. 4. The magnetic member 62 will be sandwiched between the tray 40 and the base 56 when these two members are secured together. The cavity 60 prevents the magnetic member 62 from appreciably moving in any direction a considerable amount. The magnetic member 62 exerts a sufficient magnetic attraction through the base 56 to releasably attach the magnetic storage device 10″ to a magnetically attractive surface. The upper surface 58 of the base 56 can include a flange 63. The flange 63 can be sized and configured to match the flange 52 formed on the tray 40. The flange 63 should extend horizontally outward from the base 56.

The magnetic storage device 10″ can further include a cover 64 which is sized and configured to fit over the tray 40 and can rest against the upper surface 58 of the base 56. The cover 64 can be constructed from a clear or transparent material, such as clear plastic, so that the articles 12 positioned on the tray 40 are visible to the naked eye. The cover 64 can be constructed so that it can be completely removed from the tray 40, as depicted in FIG. 9, or it can be secured to the tray 40 by one or more hinges (not shown). In either embodiment, the cover 64 should allow easy access to the batteries 38 housed on the tray 40.

The cover 64 has an upper surface 66 and a lower surface 68. The cover 64 also has a hollow cavity 70 which is open to the lower surface 68. The hollow cavity 70 is sized and configured to fit over the tray 40 and contact the flange 52. Desirably, the hollow cavity 70 is sized and configured to mate with at least a portion of the outer periphery 54 of the tray 40. The upper surface 66 of the cover 64 forms a plateau 72 having side walls 74. Four sidewalls 74, 74, 74 and 74 are present in FIG. 9 although only two of the side walls 74, 74 are visible in this view. It should be understood that if the cover 64 was formed with a circular configuration, than it would have one continuous sidewall 74. If the cover 64 was formed with a triangular configuration, than it would have three sidewalls 74, 74 and 74.

The four sidewalls 74, 74, 74 and 74 extend downward a desired amount and terminate at a flange 76. The flange 76 can vary in size and shape. The amount the flange 76 extends horizontally outward from one or more of the sidewalls 74, 74, 74 and 74 can also vary. Typically, the amount that the flange 76 can extend outward from at least one of the sidewalls 74, 74, 74 and 74 will range from between about 0.1 inches to about 6 inches or more. In the embodiment shown in FIGS. 5-7 and 9, the portion of the flange 76 extends upwards from the top edge of the plateau 72 and has a greater dimension than the portions which extend outward from the left, right and bottom edges of the cover 64. However, one can size and shape the flange 76 to any desired dimension and configuration.

In FIG. 9, the portion of the flange 76 that extends upwards from the top edge of the plateau 72 includes a printable surface 78. The printable surface 78 can be formed from paper, paper board, cardboard or some other material on which one can print or write. For example, the printable surface 78 can be an adhesive backed paper that is secured to a portion of the flange 76. The printable surface allows information and/or advertisements about the batteries 38 retained in the magnetic storage device 10″ to be displayed. Such information can include but is not limited to: the price of the batteries 38, the name of the batteries 38, the manufacturer of the batteries, the size of the batteries 38, the life of the batteries 38, etc.

Referring to FIGS. 5, 7 and 9, one or more openings 80 can be formed in the flange 76. The openings 80 are spaced apart from one another and function as a means for supporting the magnetic storage device 10″ on one or more horizontal hooks (not shown) normally found in a retail outlet. The horizontal hooks provide an efficient way to mount a plurality of the magnetic storage devices 10″ adjacent to one another and in a compact fashion on vertical peg board at a retail store. Such an arrangement allows consumers to readily view the batteries 38 and remove one or more of the magnetic storage devices 10″ when they are ready to purchase the packages.

Referring again to FIG. 9, the magnetic storage device 10″ further includes a first attachment mechanism 82 formed on the flange 63 of the base 56. The first attachment mechanism 82 can vary in size, shape and configuration. The first attachment mechanism 82 is shown as a hollow protuberance which projects upward from the flange 63. The first attachment mechanism 82 has a closed top surface 83 and an open bottom surface (not visible in FIG. 9). Four of the first attachment mechanisms 82 are depicted with one aligned adjacent to the right side, left side, top side and bottom side of the base 56. It should be understood that one or more of the first attachment mechanisms 82 can be present on the base 56.

The magnetic storage device 10″ also includes a second attachment mechanism 84 formed on the flange 52 of the tray 40. The second attachment mechanism 84 can vary in size, shape and configuration but has to be sized, shaped and configured to mate with one of the first attachment mechanisms 82. The second attachment mechanism 84 is shown as a hollow protuberance which projects upward from the flange 52. The second attachment mechanism 84 has a closed top surface 85 and an open bottom surface (not visible in FIG. 9). The upwardly extending protuberance of the first attachment mechanism 82 is sized and configured to mate or nest with the open bottom surface of the second attachment mechanism 84. Two of the second attachment mechanisms 84, 84 are shown in FIGS. 5 and 9. However, it should be understood that one or more of the second attachment mechanisms 84 can be present on the tray 40. Each of the second attachment mechanisms 84 is sized and shaped to mate or nest with one of the first attachment mechanisms 82, 82, 82 and 82. The interaction between the first and second attachment mechanisms, 82 and 84 respectively, function to secure the tray 40 to the base 56. Desirably, a friction fit is established between the connection of the first and second attachment mechanisms, 82 and 84 respectively.

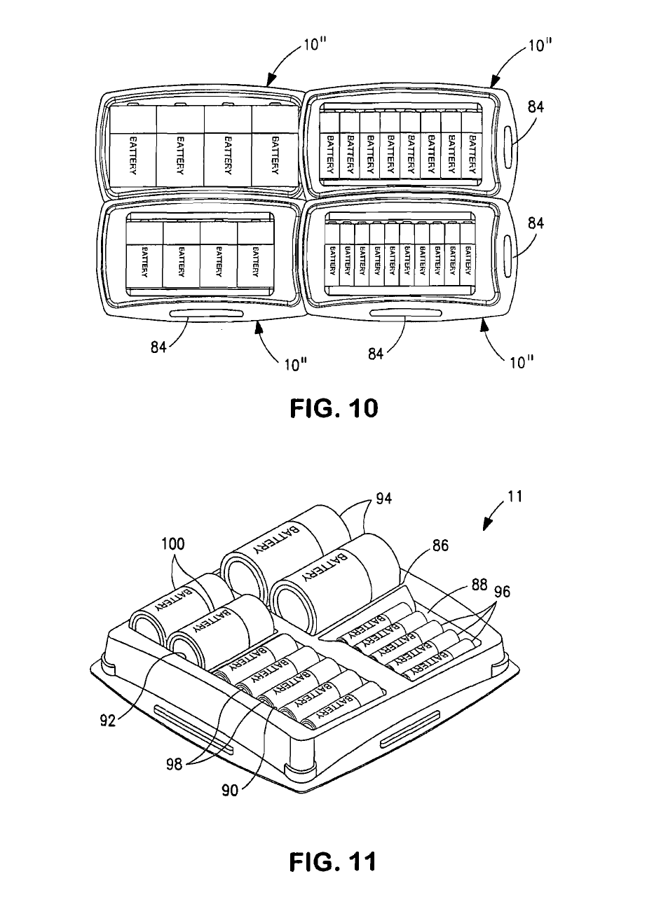

Referring now to FIG. 10, each of the second attachment mechanisms 84, 84 serve two functions. First, when the first and second attachment is mechanisms, 82 and 84 respectively, are mated or nested together, they provide a means for securing the tray 40 to the base 56. This connection can result in a friction fit, an interlocking fit, an interference fit, etc. The mating of the first and second attachment mechanisms, 82 and 84 respectively, should form a secure fit such that the tray 40 and the base 56 will not easily separate from one another. The second function served by each of the second attachment mechanisms 84 is that each provides a means for attaching or securing a second magnetic storage device 10″ to the magnetic storage device 10″.

Still referring to FIG. 10, four magnetic storage devices 10″ are shown which are assembled together. Each of the second attachment mechanisms 84 provides a way to secure one magnetic storage devices 10″ to another magnetic storage device 10″. Sometimes, it is desirable to group two or more of the magnetic storage devices 10″ together. If a magnetic storage device 10″ contains AAA size batteries 38, and a second magnetic storage device 10″ contains AA size batteries 38, and a third magnetic storage device 10″ contains A size batteries 38, then a consumer can group all three magnetic storage devices 10″, 10″ and 10″ together. When the consumer is in need of a particular size battery 38, he or she can go to one location to retrieve the correct size battery 38. The ability to mesh, overlap or connect two or more of the magnetic storage devices 10″, 10″ enhances the ability of a manufacturer to get a consumer to purchase more than one package of their articles. This can produce increased sales which will hopefully lead to increased profits.

Although one specific way to connect or mesh two or more magnetic storage devices 10″, 10″ has been described above using the second attachment mechanisms 84, one skilled in the art will understand that a variety of ways exist to connect or interlock two or more of the magnetic storage devices 10″, 10″ together. For example, one can fit, mesh or connect two or more of the magnetic storage devices 10″, 10″ together using mechanical connections. Two or more of the magnetic storage devices 10″, 10″ can be mated together by using press fits, such as a plug engaging a hollow socket; a snap fit; an interference fit, such as a ball and socket arrangement; an overlapping mechanism, such as a pintle and hook, a plug and yoke; as well as intermeshing mechanisms, such as puzzle piece connections, male and female threads, etc. Furthermore, one can insert or position a magnet in the tray 40 or base 56 portions of a magnetic storage device 10″ such that it will magnetically be attracted to another magnetic storage device 10″. Those skilled in the fastening or mating art will be aware of still other ways to provide an association between two or more of the magnetic storage devices 10″, 10″.

Referring now to FIG. 11, a magnetic storage device 11 is shown which is capable of retaining different size articles 12. The articles 12 are depicted as four different size batteries. The magnetic storage device 11 contains two or more cavities 86, 88, 90 and 92 of four different sizes. In this embodiment, there are two of the cavities 86, 86 which are sized and shaped to hold two D size batteries 94; there are five of the cavities 88, 88, 88, 88 and 88 which are sized and shaped to hold five AAA size batteries 96, 96, 96, 96 and 96; there are five cavities 90, 90, 90, 90 and 90 which are sized and shaped to hold five AA size batteries 98, 98,98,98 and 98; and two of the cavities 92, 92 which are sized and shaped to hold two C size batteries 100, 100. It should be understood that the number, size and shape of the cavities 86, 88, 90 and 92 can vary to accommodate the number, size and shape of the articles 12 one wished to retain in the magnetic storage device 11.

Method

With reference to FIG. 12, a method of assembling a magnetic storage device 10″ which is capable of retaining a plurality of articles 12, each having a thickness and a magnetic affinity, will now be explained. The method of assembling a magnetic storage device 10″ includes the steps of forming a base 56. The base 56 has an upper surface 58 with a cavity 60 formed in the upper surface 58. The cavity 60 extends downward from the upper surface 58. The method also includes forming a tray 40 having an upper surface 42, a lower surface 44 and a height h therebetween. The lower surface 44 is sized and configured to mate with the upper surface 58 of the base 56. The upper surface 42 of the tray 40 has a plurality of cavities 46 formed therein. Each of the plurality of cavities 46 has an elongated, semi-circular configuration with opposite ends. A pair of raised abutments 48, 48 is aligned adjacent to the opposite ends of each of the plurality of cavities 46. Each of the pair of raised abutments 48, 48 has an upper surface 50 which is located below the upper surface 42 of the tray 40. Each of the upper surfaces 50, 50 of the pair of abutments 48, 48 extends upward to a height that is less than the thickness of one of the plurality of articles 12 when at least one of the plurality of articles 12 is positioned in one of the plurality of cavities 46. The method further includes positioning a magnetic member 62 in the cavity 60 formed in the upper surface 58 of the base 56. The base 56 is then mated with the tray 40 such that the lower surface 44 of the tray 40 engages the upper surface 58 of the base 56. An article 12 is placed or positioned in each of the plurality of cavities 46 formed in the upper surface 42 of the tray 40.

In addition, the method can further include securing a removable cover 64 onto the tray 40 so that the articles 12 are enclosed between the cover 64 and the tray 40. The cover 64 is preferably constructed from a transparent material, such as plastic, so that one can see through the cover 64 and identify the articles 12 positioned on the tray 40.

A flange 52, 63, 76 can be formed on each of the tray 40, the base 56 and the cover 64, respectively. In addition, a first attachment mechanism 82 can be formed on the flange 63 of the base 56 and a second attachment mechanism 84 can be formed on the flange 52 of the tray 40. The first and second attachment mechanisms, 82 and 84 respectively, are capable of securing the tray 40 to the base 56. In addition, the second attachment mechanism 84 provides a means for securing a second magnetic storage device 10″ to the magnetic storage device 10″.

The method can further include securing a third magnetic storage device 10″ to the second magnetic storage device 10″ or securing the third magnetic storage device 10″ to the initial magnetic storage device 10″. Furthermore, the method can also include securing a fourth magnetic storage device 10″ to one of the other second magnetic storage devices 10″. Multiple magnetic storage devices 10″, 10″, etc. can be grouped or attached in this manner.

Lastly, the method can further include forming or attaching a printable surface 78 onto the flange 76 of the cover 64. The printable surface 78 can be in the form of an adhesive backed paper 78. The adhesive side is to secure the paper to the flange 76. The printable surface 78 should allow one to write, print, type, etc. one or more words, numbers, symbols, photos, images, etc. thereon. The information presented on the printable surface 78 can relate to the plurality of batteries 38 retained in the magnetic storage device 10″.

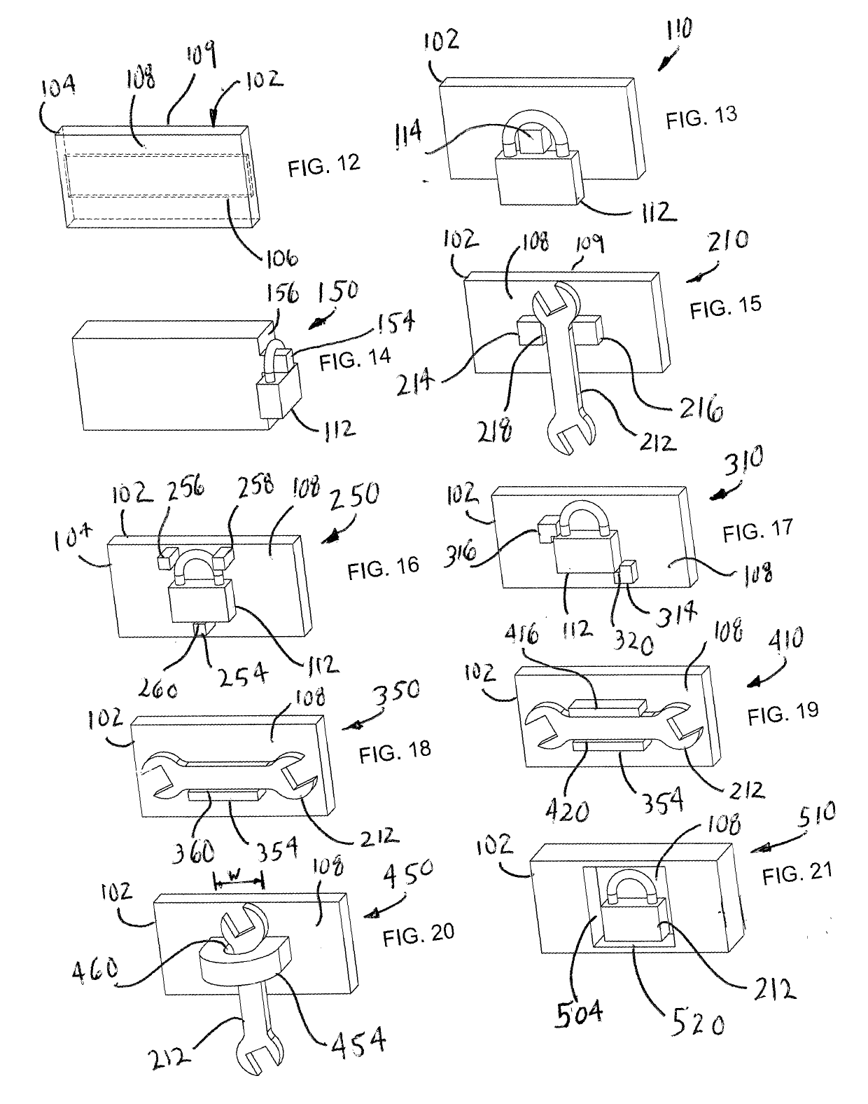

FIGS. 12-29 illustrate variations of magnetic storage device 10 shown in FIG. 1. FIG. 12 illustrates base unit 102 serving as a foundation for the magnetic storage devices shown in FIGS. 13-29. Base unit 102 comprises back 104 and magnet 106. Back 104 contains and holds magnet 106. In one implementation, back 104 comprises a two-piece assembly including a base and a tray, wherein the base and tray are welded, fastened, snapped or otherwise joined to one another with magnet 106 therebetween. In another implementation, back 104 may comprise a body having an opening into which magnet 106 is inserted. In the example illustrated, back 104 has a front face 108 and a rear face 109. Rear face 109 is configured to be supported against a vertical plane or wall, either through use of magnet 106 or through use of a hang hole, hanger, fastener or other mounting mechanism.

Magnet 106 comprises an elongate magnetic strip, bar or band position within back 104. In some implementations, magnet 106 may be supported are mounted along back face 109 of back 104. Magnet 106 has a sufficient magnetic strength so as to magnetically attract and releasably hold articles supported along back 104.

FIG. 13 illustrates magnetic storage device 110. Magnetic storage device 110 includes base unit 102 (described above) and protruberance 114. Protuberance 114 comprises a projection or other structure extending from face 108 so as to engage a portion of an article 112 having a magnetic affinity. In the example illustrated, protuberance 114 comprises a post which is encircled by a portion of article 112 such that article 112 hangs from protuberance 114. Protuberance 114 is configured such that article 112 is held, but is free to rotate about an axis parallel to face 108 but for resistance against such rotation provided by magnet 106. As a result, magnet 106 not only assists in retaining article 112 on protuberance 114 to prevent accidental disc lodgment of article 112 from protuberance 114, but also further inhibits rotation of article 112 about a horizontal axis and even better inhibit accidental dislodgment of article 112. Although protuberance 114 is illustrated as having a square cross-sectional shape, in other implementations, protuberance 114 may have other cross-sectional shapes and configurations. For example, protuberance 14 may alternatively have a circular, rectangular or other shapes. In some implementations, protuberance 114 may comprise a hook.

FIG. 14 illustrates magnetic storage device 150, another implementation of magnetic storage device 110. Magnetic storage device one or 15 is similar to magnetic storage device 110 except that device 150 includes protuberance 154 which extends from a side face 156 of back 104. As shown by FIG. 14, protuberance 154 holds article 112 (shown as a padlock) such that article 112 is free to rotate about an axis parallel to face 108 but for resistance against such rotation provided by magnet 106.

FIG. 15 illustrates magnetic storage device 210. Magnetic storage device 210 comprises base unit 102 and protuberances 214, 216. Protuberances 214, 216 project from face 108 at spaced apart locations along face 108 to form a recess 218 that is configured to receive article 212 such that article 212 may hang from protuberances 214, 216 while being free to rotate about an axis parallel to face 108 but for resistance against such rotation provided by magnet 106. In the example illustrated, article 212 (shown as a wrench) rests upon upper surfaces of protuberances 214, 216 while vertically extending above and below protuberances 214, 216. In the example illustrated, article 212 is supported such that it may freely rotate about an axis perpendicular to face 108 but for releasable resistance provided by magnetic forces of magnetic 106. Although protuberances 214, 216 are illustrated as having rectangular cross-sectional shapes, in other implementations, protuberances 214, 216 may have other cross-sectional shapes and configurations.

FIG. 16 illustrates magnetic storage device 250. Magnetic storage device 250 comprises base unit 102 and protuberances 254, 256 and 258. Protuberances turned 54, 1256 and two and 58 comprise projections extending from base 108 which are configured a hold article 112 such that article 112 is free to rotate about an axis parallel to the face but for resistance against such rotation provided by magnet 106 (shown in FIG. 12). In particular, one or more of protuberances 254, 256 and 258 are sufficiently flexible to allow article hundred 12 to be manually rotated about an axis parallel to face 1084 dislodgment of article 112. Accidental dislodgment is inhibited by magnetic forces of agate 106 exerted upon portions of article 1 or 12 having a magnetic affinity. The example illustrated, protuberance 254 forms a ledge 260 which underlies a sports article 112. Protuberances 256, 258 engage opposite side portions of article 112 above protuberance 254 to hold article 112. Because protuberances 254, 256 and 258 are spaced apart from one another and merely engage particular spaceport and of article 112 about a periphery of article 112 (rather than continuously engaging the entire periphery of article 112 adjacent to base 104), a greater extent of article 112 may be viewed and inspected when stored or when presented for retail sale. In other implementations, protuberances 254, 256 and 258 may have other configurations and may be configured to similarly hold and retain other articles other than the particular padlock shown. In other implementations, additional protuberances may be provided for holding article 112.

FIG. 17 illustrates magnetic storage device 310. Magnetic storage device 310 comprises base unit 102 and protuberances 314, 316. Protuberances 314, 316 comprise projections extending from face 108 so as to hold article 112 (shown as a padlock) such that article 112 is free to rotate about an axis parallel to face 108 but for resistance against such rotation provided by magnet 106. The example illustrated, projection 314, 316 or rubberlike or sufficiently flexible such a permit article on 12 to be manually rotated about an axis parallel to the face 108. In the example illustrated, protuberance 314 and protuberance 316 engage opposite corners of article 112, allowing visual inspection of a greater extent of article 112. In the example illustrated, protuberance 304 forms a ledge 320 stones over and above an upwardly facing shoulder of article 112. In other implementations, protuberances 254, 256 and 258 may have other configurations and may be configured to similarly hold and retain other articles other than the particular padlock shown. In other implementations, additional protuberances may be provided for holding article 112.

FIG. 18 illustrates magnetic storage device 350. Magnetic storage device 350 comprises base unit 102 and protuberance 354. Protuberance 354 comprises a ledge 360 underlying supporting article 212 (shown as a wrench that is completely form from a material having magnetic affinity or includes portions that have a magnetic affinity, i.e. a ferrous material). Ledge 360 merely engages an underside of article 2 are and 12, permitting a greater extent of article 212 to be visually inspected while being supported. Protuberance 354 holds article 212 such that article 212 is free to rotate about an axis parallel to face 108 but for magnetic resistance against such rotation provided by magnet 106. Magnet 106 exerts a magnetic force inhibiting rotation of article 212 about a horizontal axis away from face 108 and off of ledge 360. In other implementations, protuberance 354 may have other configurations and may be configured to similarly hold and retain other articles other than the particular wrench shown. In other implementations, additional protuberances may be provided for holding article 212.

FIG. 19 illustrates magnetic storage device 410. Magnetic storage device 410 comprises base unit 102, protuberance 354 and protuberance 416. Protuberance 416 comprises a projection extending from face 108 opposite to projection 354 and spaced from projection 354 so as to form a horizontal channel 420 which receives article 212 (shown as a wrench). In one implementation, channel 420 sufficiently large or wide so as to permit article 212 to pivot a rotate about a horizontal axis parallel to face 108. In other implementations, protuberances 354 and 416 provide a friction fit with article 212, wherein article 212 is removed by pulling article 212 along an axis perpendicular to face 108 against the friction force of protuberances 354, 416 against the magnetic force of magnet 106. Although magnetic storage device 410 is illustrated as including two spaced protuberances, in other implementations, magnetic storage device 410 may include a greater number of upper or lower spaced protuberances. Although such protuberances are illustrated as rectangular bars, in other implementations, such protuberances may have other shapes and sizes depending upon the article to be held.

FIG. 20 illustrates magnetic storage device 450. Magnetic storage device 450 comprises base unit 102 and protuberance 454. Protuberance 454 comprises a projection configured to hold article 212 such that article 212 is free to rotate about an axis parallel to face 108 but for resistance provided by magnetic forces against such rotation provided by magnet 106 (shown in FIG. 12). In the example illustrated, protuberance 454 comprises a ring or other shape forming an asymmetric opening 460 from which article 212 may hang when article 212 is in a first orientation with respect to a vertical axis in which portions of article 212 above opening 460 are wider than the size of the opening in a direction parallel to face 108 and through which article 212 may be withdrawn when article 212 is in a second orientation with respect to the vertical axis. In the example illustrated, article 212 has a width W which is wider than a width of opening 460 extending in a direction parallel to face 108 and which is less than a length of opening 460 extending in a direction perpendicular to face 108. In operation, magnet 106 applies a magnetic force to bias article 212 towards the first orientation such that the width of article 212 extends in a direction parallel to face 108 to retain article 212 in an orientation such that article 212 hangs and cannot be withdrawn without first rotating article 212 about a vertical axis and against the bias force provided by magnet 106. In other implementations, asymmetric opening 460 may have other shapes and sizes depending upon the shape of the article 212 to be held by magnetic storage device 450.

FIG. 21 illustrates magnetic storage device 510. Magnetic storage device 510 comprises base unit 102 and cove 504. Cove 504 extends into back 104 and provides a ledge 520 upon which article 212 may rest while base unit 102 is in a vertical orientation. The protuberance forming ledge 520 permits article 212 to freely rotate about an axis parallel to face 108 but for magnetic resistance against such rotation provided by magnet 106 (shown in FIG. 12) which extends behind face 108. The free positioning of article 212 in cold 104 greater visual inspection of article 212 and also the user withdrawal of article 212. However, accidental removal or dislodgment of article 212 is inhibited by magnet 106.

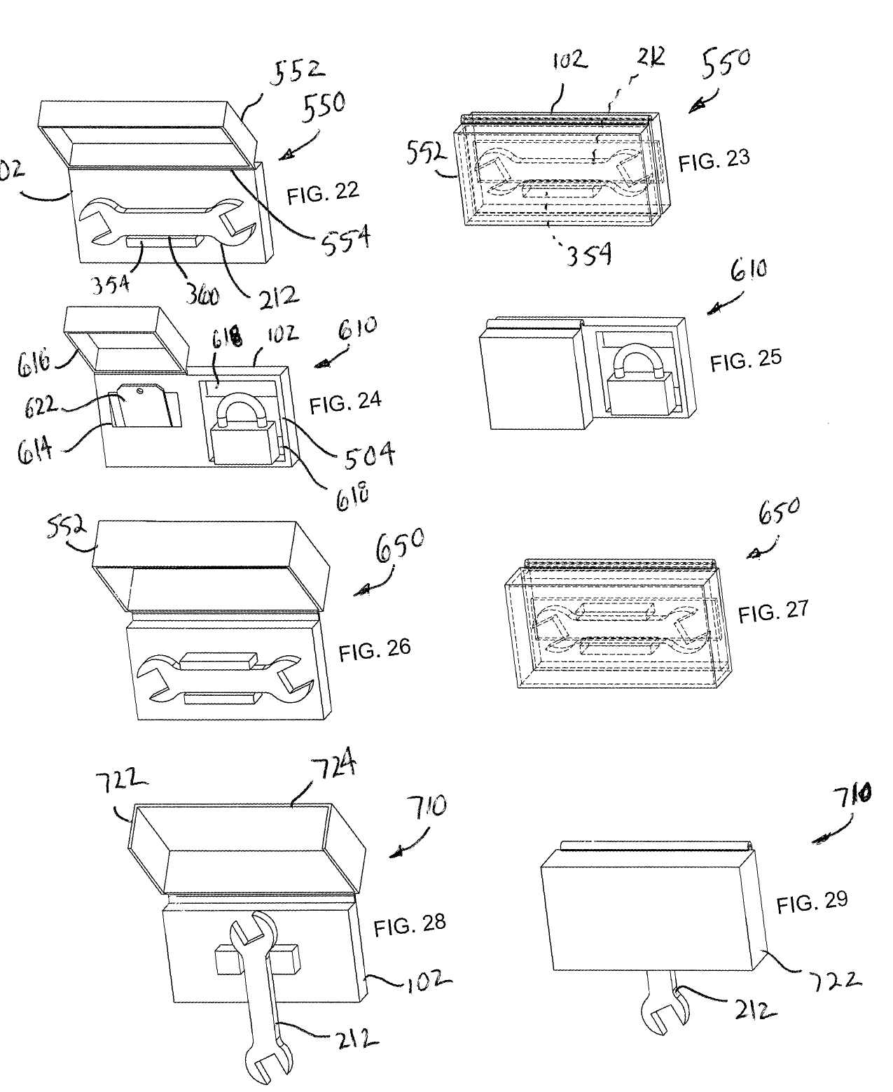

FIGS. 22-29 illustrate additional variations of magnetic storage devices. FIG. 22 illustrate magnetic storage device 550 in an open state. Magnetic storage device 550 is identical to magnetic storage device 350 except that magnetic storage device 550 additionally includes a cover 552. In the example illustrated, cover 552 is pivotably coupled to base unit 102 by hinge 554. Hinge 554 may be a living hinge, wherein cover 552 is integrally formed as part of base unit 102 or may comprise a mechanical hinge. As shown by FIG. 23 which illustrates magnetic storage device 550 in a closed state, cover 552 covers and encloses article 212 while magnet 106 retains article 212 upon ledge 360. In one implementation, cover 552 is translucent or transparent, allowing visible inspection of article 212 while cover 552 is closed.

FIG. 24 illustrates magnetic storage device 610. Magnetic storage device 610 is similar to magnetic storage device 510 except that magnetic storage device 610 additionally comprises slot 614 and cover 616. Magnetic storage device 610 further includes openings 618 through back 104 behind cove 504.

Slot 614 comprises a chamber, cavity or opening extending into back 104 to receive an additional article 622. In the example illustrated, article 622 comprises an article that does not have magnetic affinity. In the example illustrated, article 62 comprises a card which may be dropped into slot 614. In other implementations, thought 614 may other configurations depending upon the configuration of article 622.

Cover 616 comprise a structure pivotally coupled to back 104 along slot 614 first to move between an open state showing FIG. 24 and a closed state showing FIG. 25. Cover 616 covers and encloses slot 614 in the closed state of permitting access and withdrawal of article 622 within the open state. In other implementations, cover 616 may be omitted.

FIGS. 26 and 27 illustrate magnetic storage device 650. Magnetic storage device 650 is identical to magnetic storage device 410 except that magnetic storage device additionally comprises cover 552 discussed above with respect to magnetic storage device 550. FIGS. 28 and 29 illustrate magnetic storage device 710. Magnetic storage device 710 is identical to medicate storage device 210 except that ministers device seven and 10 additionally includes cover 722. Cover 722 is similar cover 552 except that cover 772 includes an open lower end 724 which permits article 2122 project beyond base unit 102. As a result, even when magnetic storage device 7 on 10 is in a closed state as shown in FIG. 29, magnetic storage device 710 permits a visual determination of whether magnetic storage device 710 contains article 212 while magnet 106 prevents accidental dislodgment of article 212.

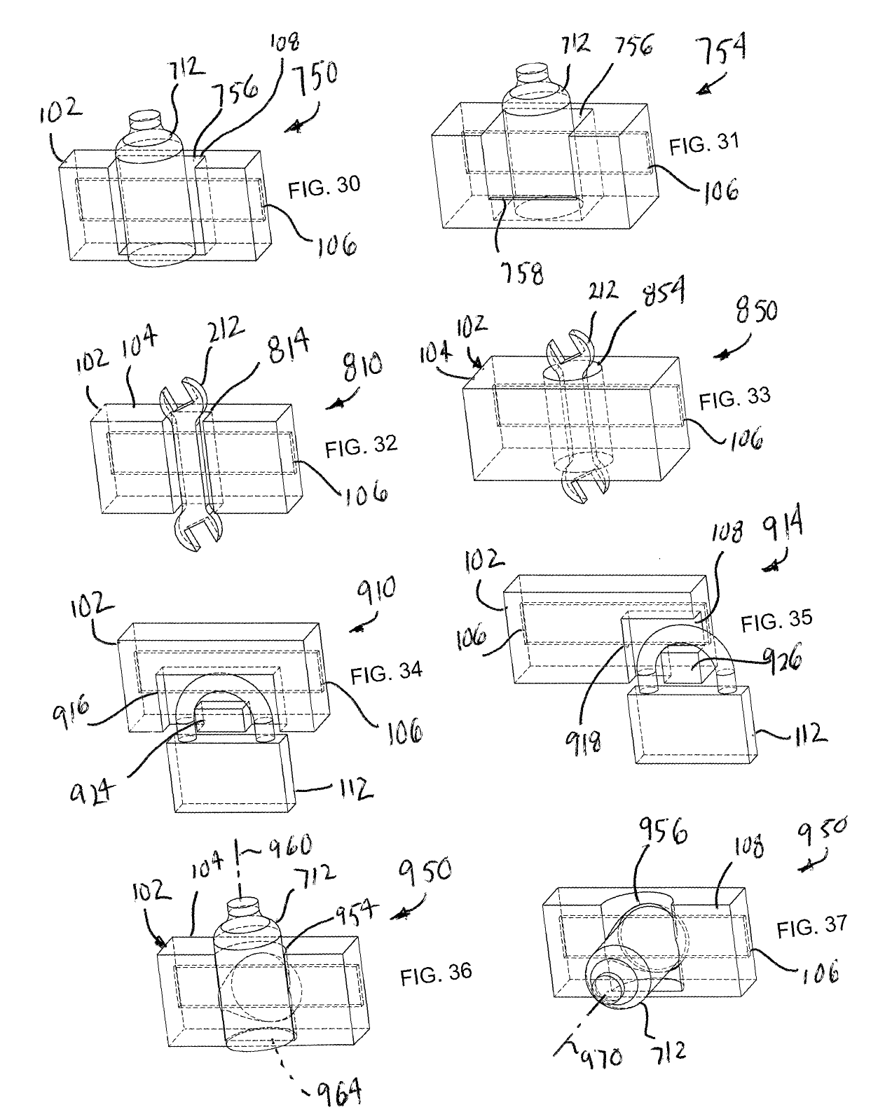

FIGS. 30 and 31 illustrate magnetic storage devices 750 and 754, respectively. Magnetic storage devices 750 and 754 each include a base unit 102 in which is formed and open topped cove 756 in front of magnet 106. Magnetic storage device 754 additionally includes a front wall run 758 to further assist in retaining article 712 within cove 756. In such implementations, magnet 106 inhibits accidental rotation of article 712 about an axis parallel to face 108 to inhibit axonal dislodgment of article 712 (shown as a bottle or container). Although cove 756 is illustrated as being rectangular in shape, in other implementations, code 756 may be semicircular of other shapes and configurations depending upon shapes and configurations of article 712.

FIG. 32 illustrates magnetic storage device 810. Magnetic storage device 810 comprises base unit 102 and vertical channel 814. Vertical channel 814 extends into back 104 in front of magnet 106. Channel 814 receives article 212, wherein article 212 is allowed to project both above and below base unit 102. As a result, base unit 102 may be smaller and more compact. At the same time, magnet 106 assists in retaining article 212 in place using magnetic forces.

FIG. 33 illustrates magnetic storage device 850. Magnetic storage device 850 comprises base unit 102 and vertical passage 854. Passage 854 extends through back 104 and completely surrounds article 212. Passage 854 is dimensioned such that article 212 may completely passed through passage 854 in a vertical direction when base unit 102 is mounted against a vertical surface such as a wall. Passage 854 extends in front of magnet 106, wherein magnet 106 applies magnetic forces to article 2122 inhibit withdrawal of article 212 from passage 854. Although passage 854 is illustrated as a cylindrical passage, in other implementations, passage 854 may have other sizes and shapes depending upon the particular size or shape or configuration of article 212. As in all of the examples illustrated, the article shown (a wrench, a padlock or a container) is but an example.

FIGS. 34 and 35 illustrate magnetic storage devices 910 and 914, respectively. Magnetic storage devices nine and 10 and 914 are similar to one another and that each of such devices includes base unit 102 and an inset cavity or cove 916, 918 extending about a protuberance 924, 926, respectively, from which article 112 hangs. Protuberances 924 926 are similar to protuberance 114 described above in that such protuberances hold article 112 such that article 112 is free to rotate about an axis parallel to the face 108 but for resistance against such rotation provided by magnet 106. Because such protuberances 924, 926 are contained within coves 916, 918, such protuberances do not project beyond base unit 102 where they may undesirably catch upon external products or other items during shipping, display or use. In the example illustrated, such protuberances 924, 926 further permit article 112 to hang beyond base unit 102 for greater visual inspection of article 112 and to provide base unit 102 with greater compactness.

FIGS. 36 and 37 illustrate magnetic storage device 950 storing or containing container 712. Magnetic storage device 950 comprises base unit 102 and openings 954, 956. Opening 954 comprises a semi-cylindrical opening extending into back 104 in front of an overlying magnet 106 and opening 956. Opening 954 is centered along (the central axis of the semi-cylindrical opening) axis 960. Opening 954 facilitates reception of container 712 with the centerline of container 712 extending parallel or coincident with axis 960. In the example illustrated, opening 954 is blind in that open 954 terminates at a lower ledge 964 persistent supporting container 712. In other implementations, opening 954 may comprise a passage completely extending vertically across back 104, allowing container 712 to project beyond the bottom of back 104 when in the vertical orientation shown in FIG. 36.

Opening 956 comprises a cylindrical opening projecting into back 104 in front of magnet 106. Opening 956 extends through the back or floor of opening 954. Opening 956 is centered along an axis 970 which is perpendicular to face 108 and perpendicular to axis 960. Opening 956 is configured to receive an axial end of container 712. Opening 956 facilitates retention of container 712 with container 712 projecting outward and orthogonal from base unit 102. Magnet 106 assists in retaining container 712 to inhibit accidental dislodgment of container 712.

Openings 954 and 956 allow container 712 to be selectively stored in either the vertical orientation shown in FIG. 36 or the horizontal orientation shown in FIG. 7. Openings 954 and 956 allow such a choice without increasing the overall footprint of the associated storage receptacle provided on back 104. Although openings 954, 956 are illustrated as being configured to receive a cylindrical object in the form of the container, openings 954, 956 may be configured to receive other cylindrical objects or articles such as hole saws, drill bits, sockets and the like.

FIG. 38 illustrates magnetic storage device 1010. Magnetic storage device 1010 comprises base unit 102, protuberance 1014 and protuberance 1016. Base unit 102 is described above with respect to FIG. 12. Protuberance 1014 projects from face 108 of back 104 a portion of article 212. Protuberance 1014 forms a hollow interior cavity 1018 that faces downward and that is configured to removably receive a portion of article 212. Cavity 1018 is sufficiently sized to permit article 212 to rotate about an axis parallel to face 108 of back 104 but for resistance against such rotation provided by magnet 106. In the example illustrated, cavity 1018 comprises a semi-spherical cylindrical cavity centered about an axis perpendicular to face 108. In other implementations, cavity 1018 and other configurations depending upon a portion of article 212 removably received by cavity 1018 and the configuration of article 212.

Protuberance 1016 comprises a projection extending from face 108 and opposite portion of article 212 as compared to protuberance 1014. In the example illustrated, protuberance 1016 comprises a post projecting from face 108 along an axis perpendicular to face 108. Protuberance 1016 is configured to be received by portion of article 212 and is sufficiently spaced from protuberance 1014 to facilitate pivoting of article 212 about an axis parallel to face 108. Although illustrated as comprising a rectangular post, in other implementations, protuberance 1016 may have other cross-sectional shapes or may other configurations depending upon the configuration of article 212.

In the example illustrated, article 212 has a center of mass 1020 (a center of gravity), wherein protuberance 1014 is on a first side of the center of mass 1020 while magnet 106 is on a second side of the center of mass 1020. Because magnet 106 is located on an opposite side of the center of mass 1020 as protuberance 1018, magnet 106 inhibits inadvertent pivoting or rotation of article 212 about center of mass 1020. As a result, protuberances 1014, 1016 cooperate to support article 212 and to permit article 212 to be rotated in a clockwise direction outward away from face 108 for withdrawal of article 212 from cavity 1018 and off of protuberance 1016. Magnet 106 prevents inadvertent dislodgment of article 212 from post 1016.

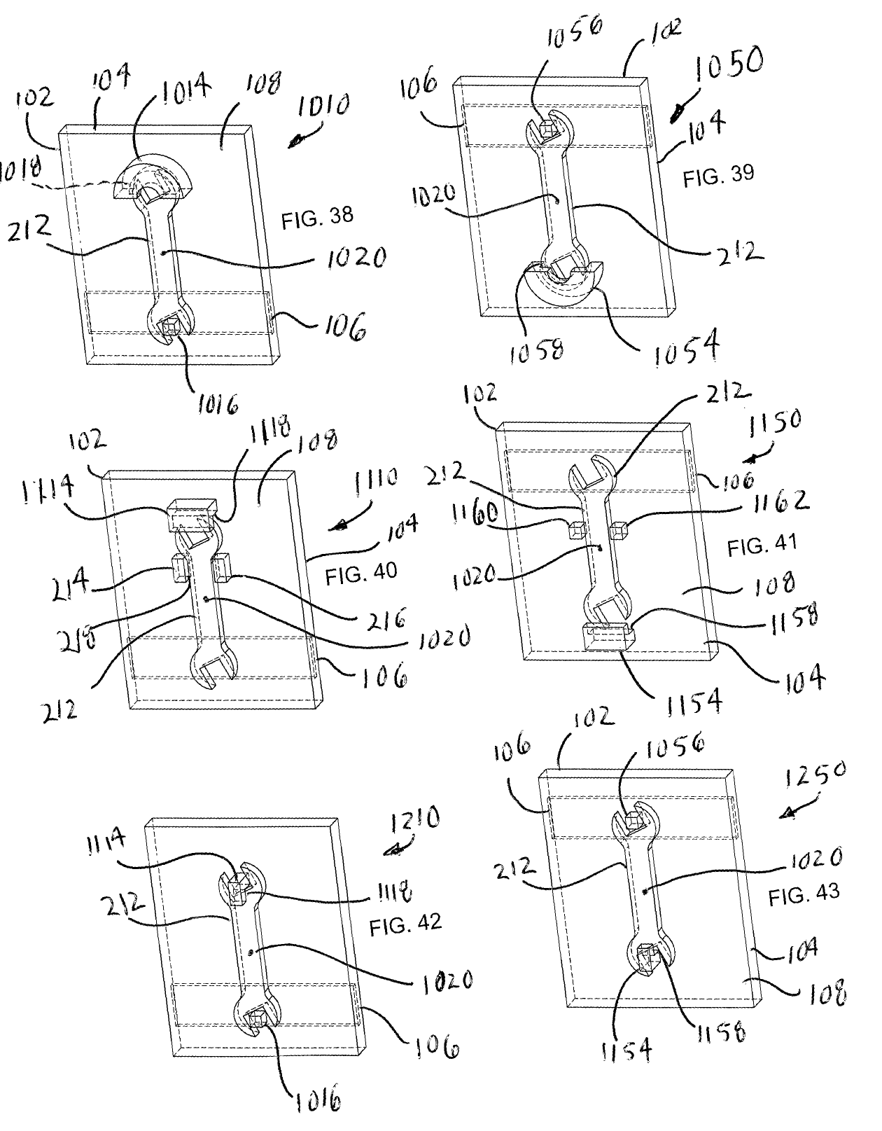

FIG. 39 illustrates magnetic storage device 1050. Magnetic storage device 1050 comprises base unit 102, protuberance 1054 and protuberance 1056. Base unit 102 is described above with respect to FIG. 12. Protuberance 1054 projects from face 108 of back 104 a portion of article 212. Protuberance 1014 forms a hollow interior cavity 1058 that faces upward and that is configured to removably receive a portion of article 212. Cavity 1058 is sufficiently sized to permit article 212 to rotate about an axis parallel to face 108 of back 104 but for resistance against such rotation provided by magnet 106. The example illustrated, cavity 1018 comprises a semi-spherical cylindrical cavity centered about an axis perpendicular to face 108. In other implementations, cavity 1018 and other configurations depending upon a portion of article 212 removably received by cavity 1058 and the configuration of article 212.

Protuberance 1056 comprises a projection extending from face 108 and opposite portion of article 212 as compared to protuberance 1054. In the example illustrated, protuberance 1056 comprises a post projecting from face 108 along an axis perpendicular to face 108. Protuberance 1056 is configured to be received by portion of article 212 and is sufficiently spaced from protuberance 1054 to facilitate pivoting of article 212 about an axis parallel to face 108. Although illustrated as comprising a rectangular post, in other implementations, protuberance 1056 may have other cross-sectional shapes or may other configurations depending upon the configuration of article 212.

In the example illustrated, article 212 has a center of mass 1020 (a center of gravity), wherein protuberance 1054 is on a first side of the center of mass 1020 while magnet 106 is on a second side of the center of mass 1020. Because magnet 106 is located on an opposite side of the center of mass 1020 as protuberance 1058, magnet 106 inhibits inadvertent pivoting or rotation of article 212 about center of mass 1020. As a result, protuberances 1054, 1056 cooperate to support article 212 and to permit article 212 to be rotated in a counter-clockwise direction outward away from face 108 for withdrawal of article 212 from cavity 1058 and off of protuberance 1056. Magnet 106 prevents inadvertent dislodgment of article 212 from post 1056.

FIG. 40 illustrates magnetic storage device 1110. Magnetic storage device 1110 is similar to magnetic storage device 210 except that magnetic storage device 1110 additionally comprises protuberance 1214 and locate magnet 106 of base unit 102 on an opposite side of protuberances 214, 216 as compared to protuberance 1214. protuberance 1214 comprise a projection extending from face 108 so as to form a cavity 1218 which faces in a downward direction. In the example illustrated, protuberance 1214 comprises an inverted L shaped member forming cavity 1218. In other implementations, cavity 1218 may be provided by other configurations of protuberance 1214. Cavity 1218 receives a portion of article 212 having a center of mass 1020. Cavity 1218 is sufficiently sized to permit article 2012 to be rotated or pivoted about a horizontal axis parallel to face 108 last to dislodge article 2012 from protuberances 214, 216 as well as from cavity 1218 of protuberance 1214. Because magnet 106 is on opposite side of the center of mass 1020 and on an opposite side of protuberances 214, 216 as cavity 1218, magnet 106 inhibits pivoting of article 212. Magnet 106 further inhibits accidental dislodgment of the upper portion of article 2012 resting upon protuberances two 114, 216.

FIG. 41 illustrates magnetic storage device 1150. Magnetic storage device 1150 comprises base unit 102, protuberances 1154, 1160 and 1162. Protuberance 1154 comprises a projection extending from face 108 of back 104 so as to form a cavity 1158. Cavity 1158 receives a lower end portion of article 2012. Cavity 1158 is sufficiently wide enough to permit pivoting a rotation of article 212 in a counter-clockwise direction away from face 108. In the example illustrated, protuberance 1154 comprises an L-shaped member forming cavity 1158. In other implementations, procurement 1154 may have other configurations for receiving a lower portion of article 212.

Protuberances 1160, 1162 comprise projections extending from face 108 so as to engage opposite sides of article 212 to inhibit rotation of article 212 about an axis perpendicular to face 108. In the example illustrated, article 212 has a center of mass 1020. Protuberances 1160 and 1162 are at or above the center of mass 1020. Because magnet 106 is on opposite side of the center of mass 1020 and on opposite side of protuberances 1160, 1162 as protuberance 1154 providing cavity 1158, magnet 106 inhibits accidental dislodgment of article 212 from cavity 1158.

FIG. 42 illustrates magnetic storage device 1210. Magnetic storage device 1210 is similar to magnetic storage device 1110 except that magnetic storage device 1210 omits protuberances 214, 216 and additionally comprises protuberance 1016. FIG. 43 illustrates magnetic storage device 1250. Magnetic storage device 1250 is similar to magnetic storage device 1150 except that magnetic storage device 1250 omits protuberances 1160, 1162 and additionally comprises protuberance 1056. With each of magnetic storage devices 1210 and 1250, protuberance 1114 and 1154 not only receive a portion of article 212, but also are received through or within a portion of article 212 for enhanced securement of article 212. As with magnetic storage devices 1010, 1050, magnets 106 of storage devices 1210, 1250 inhibit accidental dislodgment of article 212 from protuberances 1016, 1056, respectively.

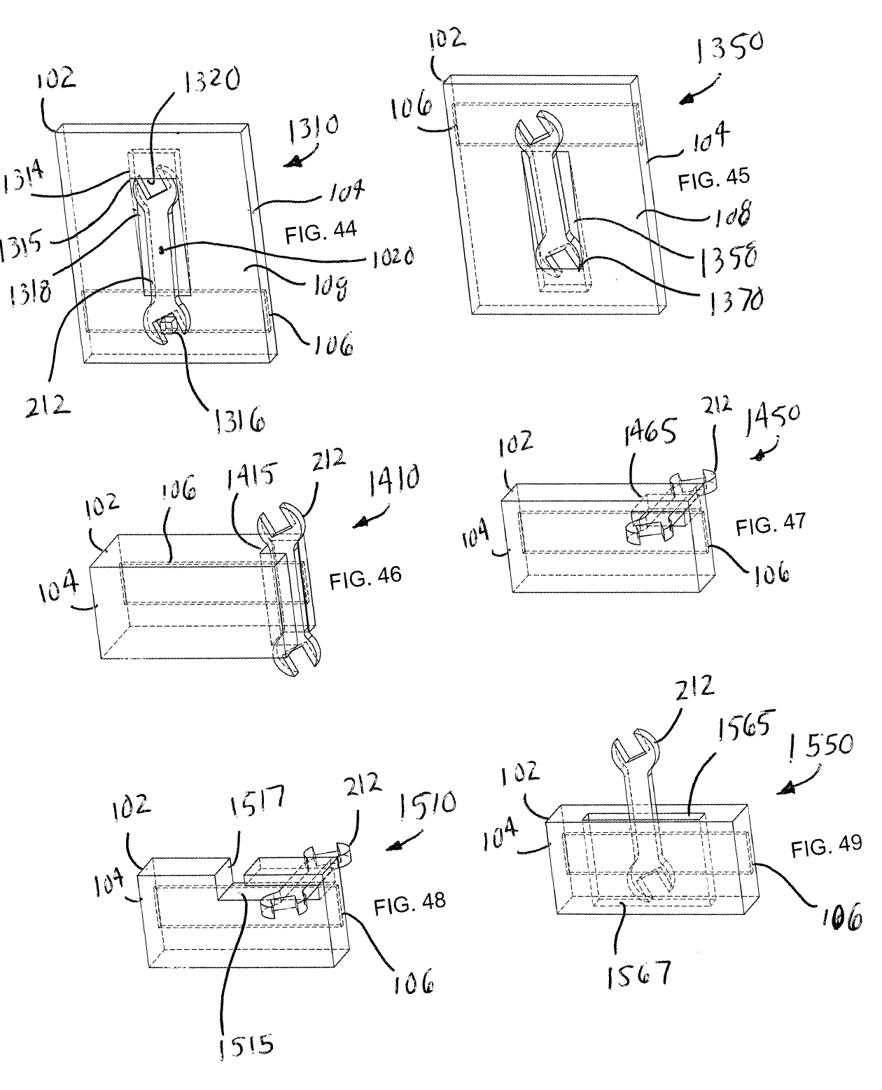

FIG. 44 illustrates magnetic storage device 1310. Magnetic storage device 1310 comprises base unit 102, protuberance 1314 and protuberance 1316. Protuberance 1314 projects forwardly from a recessed portion 1318 of face 108 of back 104 to form a pocket 1320. Pocket 1320 is configured to receive an upper portion of article 212. Pocket 1320 is sufficiently large so as to permit pivoting of article 2012 about a horizontal axis parallel to face 108 four dislodgment of article 2012 from protuberance 1316 and withdrawal from pocket 1320.

Protuberance 1316 comprises a projection, such as a post, extending from face 108 so as to engage a lower portion of article 212. In the example illustrated in which article 2 and 12 comprises a wrench, protuberance 1316 is configured to be received within a lower portion of article 2012. In other implementations, protuberance 1316 may alternatively merely engage or may receive a portion of article 212.

As noted above, article 212 has a center of mass 1020, wherein magnet 106 is located on an opposite side of center of mass 1020 as pocket 1320. As a result, magnet 106 better inhibits pivoting of article 212 to prevent accidental dislodgment of article 212 from protuberance 1316. At the same time, because article 212 is merely held onto protuberance 1316 by magnetic forces from magnet 106, article 212 may be easily removed from base unit 102 when desired.

FIG. 45 illustrates magnetic storage device 1350. Magnetic storage device 1350 comprises base unit 102 and protuberance 1354. Protuberance 1354 projects forwardly from a recessed portion 1358 of face 108 of back 104 to form a pocket 1370. Pocket 1370 is configured to receive a lower portion of article 212. Pocket 1370 is sufficiently large so as to permit pivoting of article 212 about a horizontal axis parallel to face 108 for withdrawal of article 212 from pocket 1370. As noted above, article 212 has the center of mass 1020, wherein magnet 106 is located on an opposite side of center of mass 1020 as pocket 1370. As a result, magnet 106 better inhibits pivoting of article 2012 to prevent accidental dislodgment of article 212 from pocket 1370.

FIG. 46 illustrates magnetic storage device 1410. Magnetic storage device 1410 comprises base unit 102 (described above) and passage 1415. Passage 1415 extends through backing 104 in a vertical direction proximate to magnet 106. Passage 1415 is configured to receive at least a portion of article 212. Magnet 106 assists in maintaining article 212 within passage 1415 releasably secured to backing 104. As a result, article 212 may be easily withdrawn from backing 104 as desired.

FIG. 47 illustrates magnetic storage device 1450. Magnetic storage device 1450 is similar to magnetic storage device 1410 except that magnetic storage device 1450 comprises a passage 1465 horizontally extending through backing 104 of base unit 102. Passage 1415 receives and maintains article to learn 12 in a horizontal orientation. Magnet 106 applies magnetic forces to article 212 to inhibit accidental dislodgment of article 212 from passage 1465.

FIG. 48 illustrates magnetic storage device 1510. Magnetic storage device 1510 comprises base unit 102 and passage 1515. Passage 1515 extends horizontally through back 104 of base unit 102 and includes an upward facing mouth or opening 1517. Passage 1515 receives article 212 either in a horizontal direction or vertically through opening 1517. Passage 1515 enables article 212 to be horizontally slid to a position opposite to mouth 1517 and to be subsequently lifted through mouth 1517. Magnet 106 inhibits inadvertent movement of article 2 112 horizontally out of passage 1515 or vertically through mouth 1517.

FIG. 49 illustrates magnetic storage device 1550. Magnetic storage device 1550 comprises base unit 102 (described above) and pocket 1565. Pocket 1565 vertically extends downward three top of back 104 and terminate at a floor bottom 1567. Pocket 1565 receives article 212. Magnet 106 and resistor withdrawal of article 212 from pocket 1565 and inhibits accidental removal of article 212.

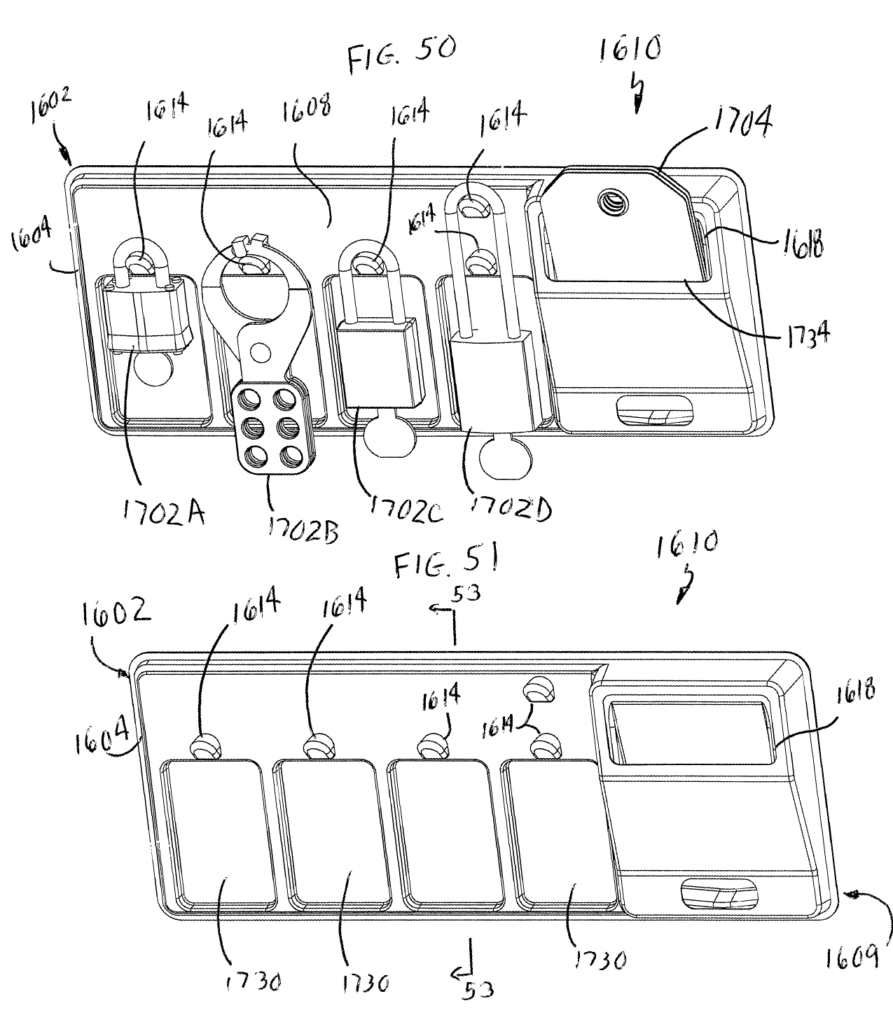

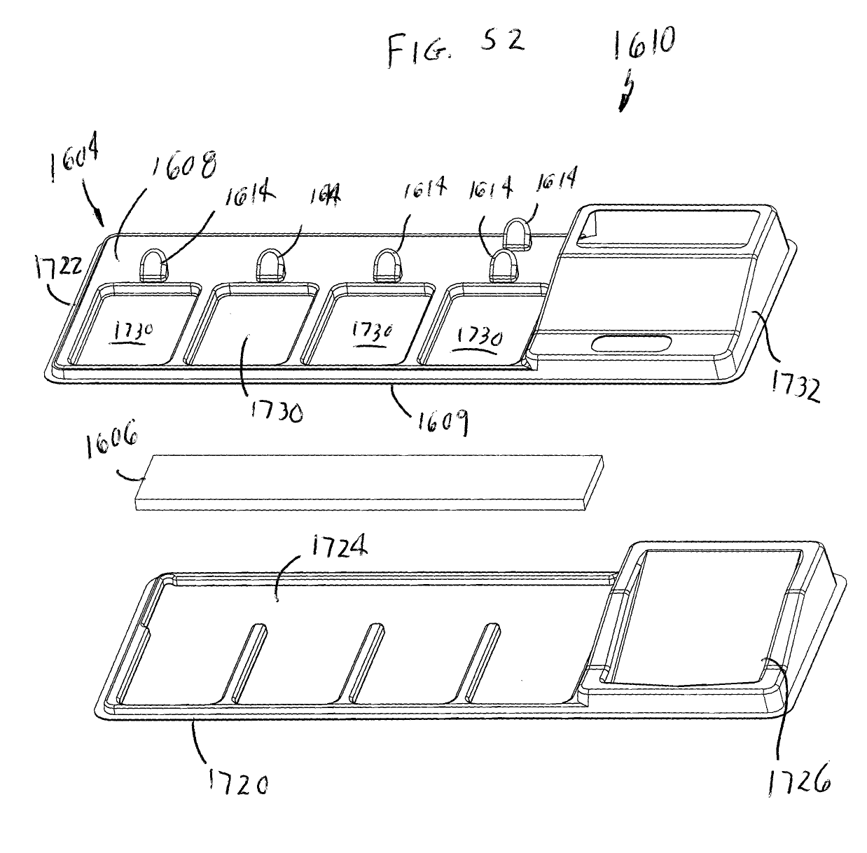

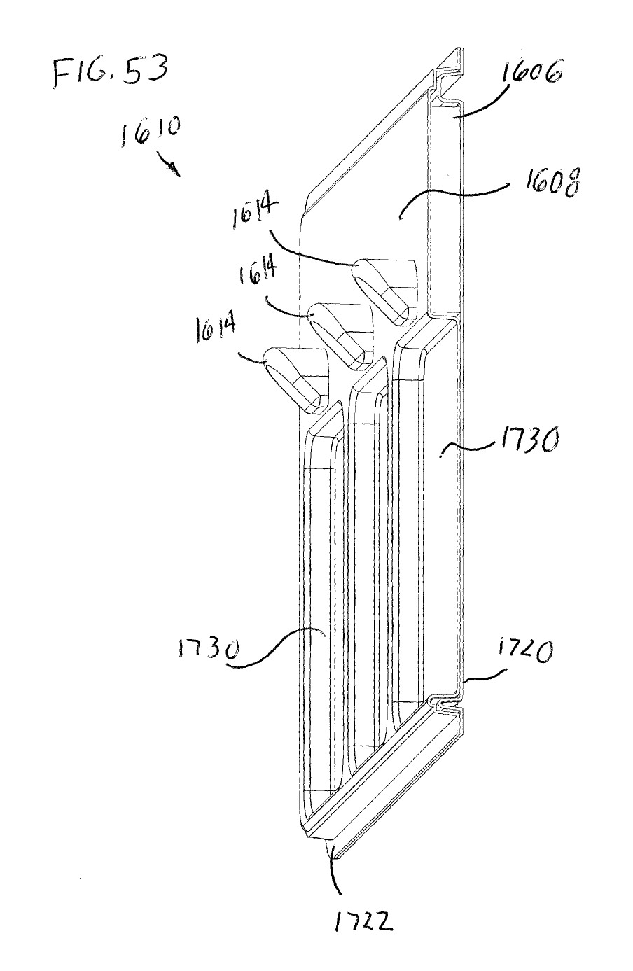

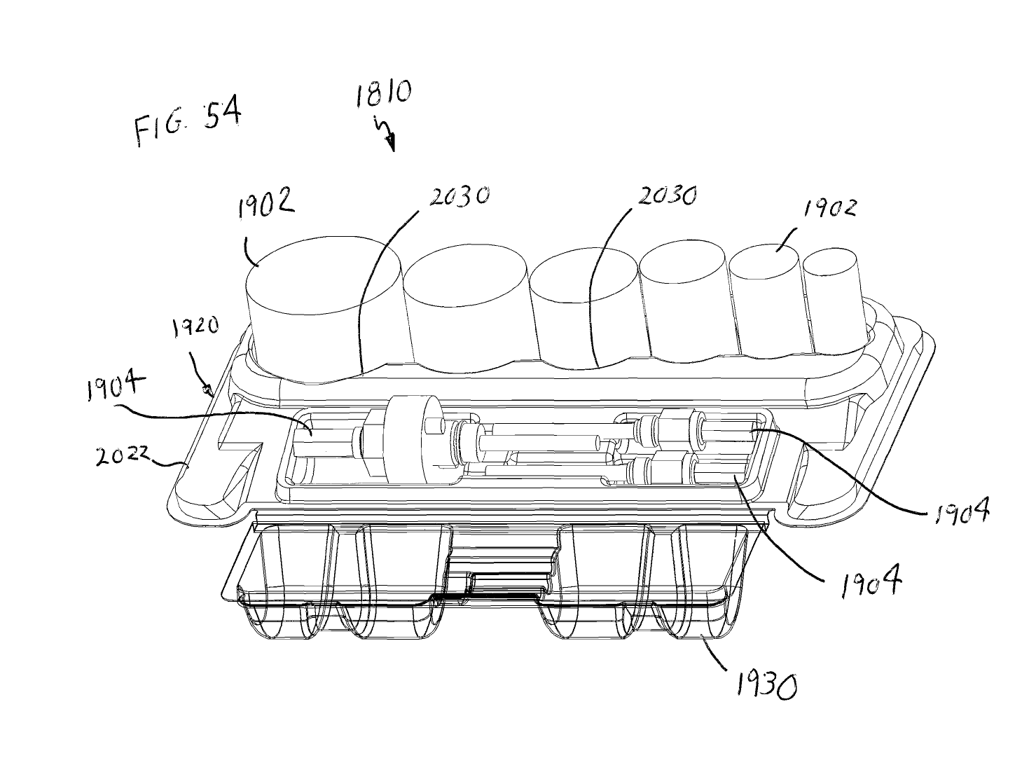

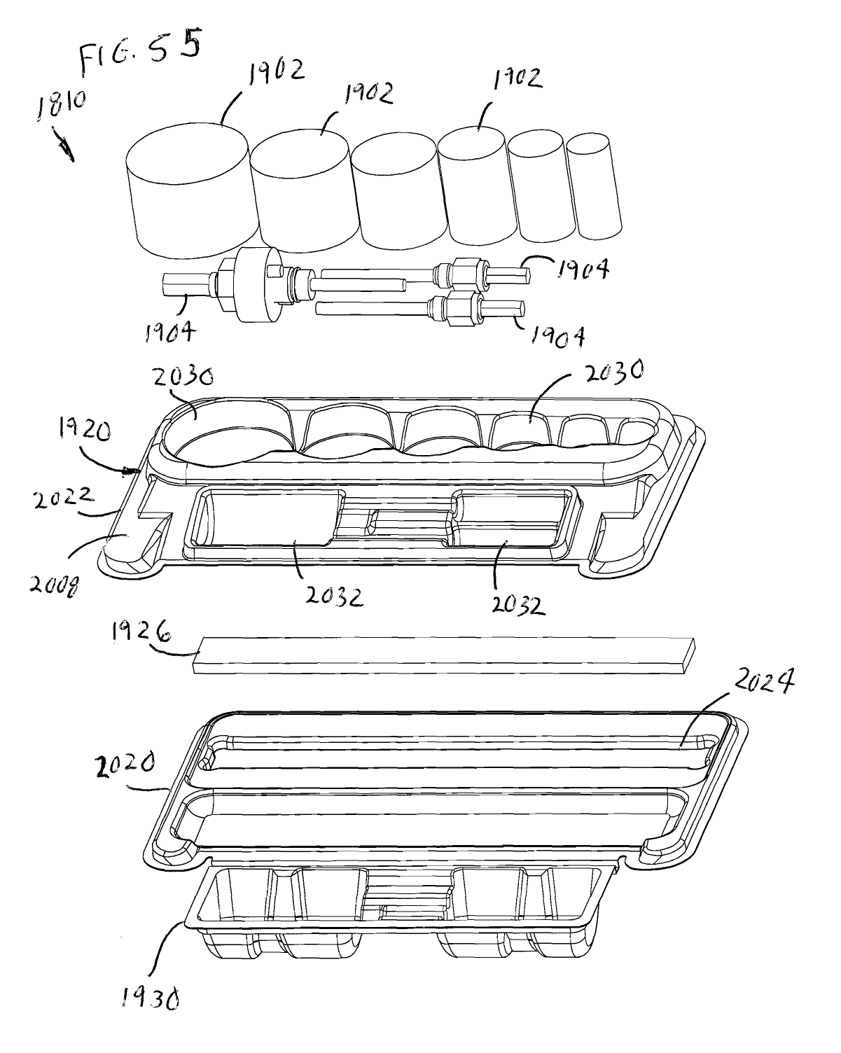

FIGS. 50-53 illustrate magnetic storage device 1610. FIG. 15 illustrates magnetic storage device 1610 storing and presenting articles 1702A, 1702B, 1702C, 1702D (collectively referred to as article 1702) and articles 1704. FIG. 51 illustrates magnetic storage device 1610 without such articles. FIG. 52 is an exploded perspective view of magnetic storage device 1610. FIG. 53 is a sectional view of magnetic storage device 1610 taken along line 53-53 of FIG. 51. In the example illustrated, article 1702 comprise products having magnetic affinity such that they are attracted to magnets. In the example illustrated, article 1702A, 1702C and 1702D comprise padlocks. Article 1702B comprises a multi-lockout. Articles 1704 comprise tags having no magnetic affinity. In other implementations, magnetic storage device 1610 may hold and store other articles having magnetic affinities as well as other non-magnetic or nonferrous articles.

Magnetic storage device 1610 comprises base unit 1602, protuberances 1614 and card or tag holder pocket 1618. Base unit 1602 comprises back 1604 and magnet 1606 (shown in FIG. 52). Back 104 contains and holds magnet 106. Back 1604 is configured to be supported against a vertical plane or wall, either through use of magnet 1606 or through use of a hang hole, hanger, fastener or other mounting mechanism.

In the example illustrated, back 1604 comprises a two-piece assembly including a base 1720 and a tray 1722, wherein the base and tray are welded, fastened, snapped or otherwise joined to one another with magnet 1606 therebetween. In another implementation, back 1604 may comprise a body having an opening into which magnet 1606 is inserted. In the example illustrated, base 1720 includes a recess or channel 1724 which receives and retains in place magnet 1606. Tray 1720 further includes a back portion 1726 of pocket 1618.

Tray 1722 of back 104 has a front face 1608. Tray 1722 further comprises cavities 1730 and pocket front 1732. Cavities 1730 extend below protuberances 1614 for partially receiving articles 1702 to frame articles 1702. Pocket front 1732 cooperates with back portion 1726 to form pocket 1618 which includes an opening slot 1734 for receiving tags or cards.

Magnet 106 comprises an elongate magnetic strip, bar or band position within back 1604. In some implementations, magnet 1606 may be supported or mounted along back face 1609 of back 104. Magnet 106 has a sufficient magnetic strength so as to magnetically attract and releasably hold articles 1702 supported along back 1604.

Protuberances 1614 comprise projections or other structure extending from face 1608 so as to engage a portion of an article 1702 having a magnetic affinity. In the example illustrated, protuberance 1614 comprises a post which is encircled by a portion of article 1702 such that article 1702 hangs from protuberance 1614. Protuberance 1614 is configured such that article 1702 is held, but is free to rotate about an axis parallel to face 1608 but for resistance against such rotation provided by magnet 1606. As a result, magnet 1606 not only assists in retaining article 1702 on protuberance 1614 to prevent accidental disc lodgment of article 1702 from protuberance 1614, but also further inhibits rotation of article 1612 about a horizontal axis and even better inhibits accidental dislodgment of article 1612. Although protuberance 1614 is illustrated as having a semi-cylindrical shape, in other implementations, protuberance 1614 may have other cross-sectional shapes and configurations. For example, protuberance 14 may alternatively have circular, rectangular or other shapes. In some implementations, protuberances 1614 may comprise a hook.

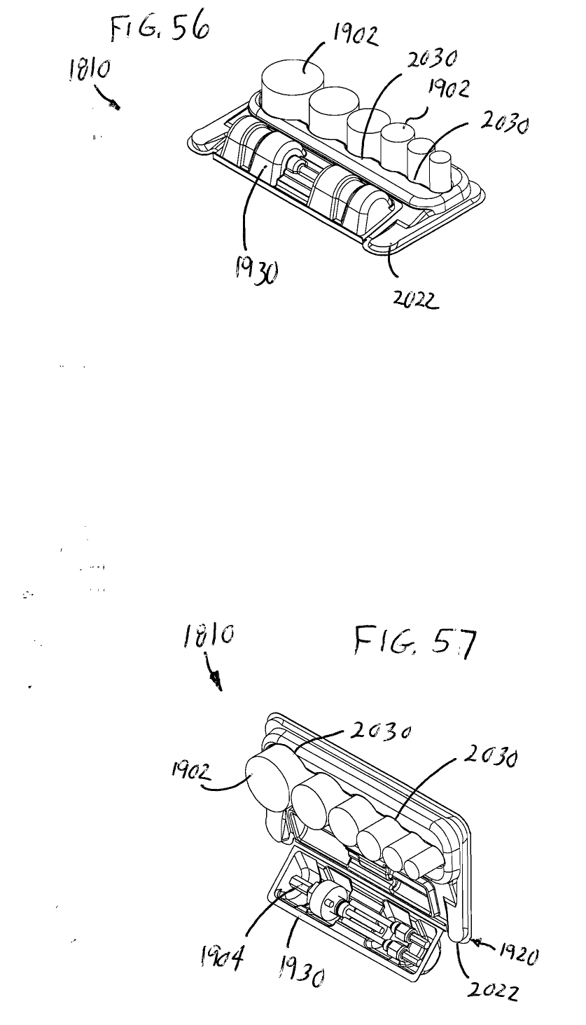

FIGS. 54-58 illustrate magnetic storage device 1810. FIG. 54 illustrates magnetic storage device in a horizontal orientation with an open cover and containing articles 1902, 1904. FIG. 55 is an exploded perspective view of magnetic storage device 1810 without such articles. FIG. 56 illustrates magnetic storage device in a horizontal orientation with a closed cover. FIG. 57 illustrates magnetic storage device 1810 in a vertical orientation with the articles. Articles 1902 comprise articles that have a magnetic affinity, wherein at least a portion of such articles is formed from a ferrous material. Articles 1904 comprise articles that do not have such a magnetic affinity. In the example illustrated, article 1902 comprise cylindrical articles such as hole saws while articles 1904 comprise arbors for use with articles 1902. In other implementations, magnetic storage device 1810 may be licensed or other combinations of articles that have and do not have magnetic affinity.

Magnetic storage device 1810 comprises back 1920, magnet 1926 and cover 1930. In the example illustrated, back 1604 comprises a two-piece assembly including a base 2020 and a tray 2022, wherein the base and tray are welded, fastened, snapped or otherwise joined to one another with magnet 1926 therebetween. In another implementation, back 2020 may comprise a body having an opening into which magnet 1926 is inserted. In the example illustrated, base 2020 includes a recess or channel 2024 which receives and retains in place magnet 1926. In other implementations, magnetic storage device 1810 may omit base 2020, wherein magnet 1926 is otherwise adhered to tray 2022.

Tray 2022 has a front face 2008 into which are formed recesses, cavities or receptacles 2030 and recesses, cavities or receptacles 2032. Receptacles 2030 are configured to receive articles 1902 and support articles opposite to magnet 1926 which is retained within channel 2024 (shown in FIG. 5). As a result, magnet 1926 assists in retaining articles 1902 within receptacles 2030 regardless of an orientation of magnetic storage device 1810. Receptacles 2032 are spaced from magnet 1926. In one implementation, receptacles 2032 are configured to contain articles that do not have a magnetic affinity. In another implementation, receptacles 2032 are configured to receive articles that do have a magnetic affinity, but which are not sufficiently close to magnet 1926 to be held by magnet 1926.

Cover 1930 comprises a structure pivotably coupled to or hinged to base 2020 of back 1920. In the example illustrated, cover 1930 is integrally formed as part of a single unitary body with base 2020, a living hinge being formed between base 2020 and cover 1930. Cover 1930 pivots between a first position in which cover 1930 covers cavities are recesses 2032 while such recesses 2030 to receive articles 1904 in a second position in which cover 1930 is inverted to form a trough below recesses 2032 when back 1920 is in a vertical orientation or extends in a vertical plane. As shown by FIGS. 54 and 56, when magnetic storage device 1810 is in a horizontal orientation, cover 1930 may be moved from a closed state (shown in FIG. 56) to an open state (shown in FIG. 54), wherein articles 1904 retained within recesses 2032 under the force of gravity. As shown by FIG. 57, when magnetic storage device 1810 is alternatively used in a vertical orientation, such as when magnetic storage device 1810 is mounted to or otherwise supported by a vertical wall or panel, cover 1930 serves as a trough to contain such articles 1904 which would not otherwise be held by magnet 1926 that would otherwise fall out of magnetic storage device 1810.

Magnet 1926 comprises an elongate magnetic strip, bar or band position within back 1920. In some implementations, magnet 1606 may be supported or mounted along back face of back 1920 rather than being contained within or as part of base 2020. In such implementations, cover 1930 may alternatively be pivotally coupled to tray 2022. Magnet 1926 has a sufficient magnetic strength so as to magnetically attract and releasably hold articles 1902 supported along back 1920.

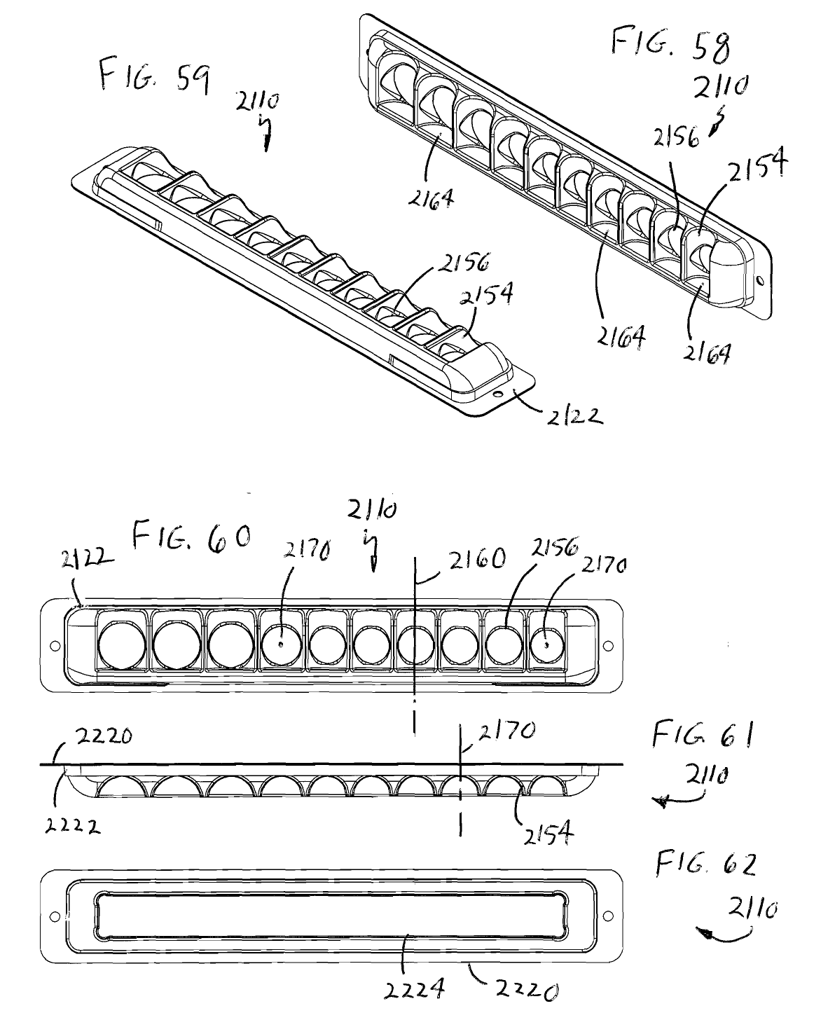

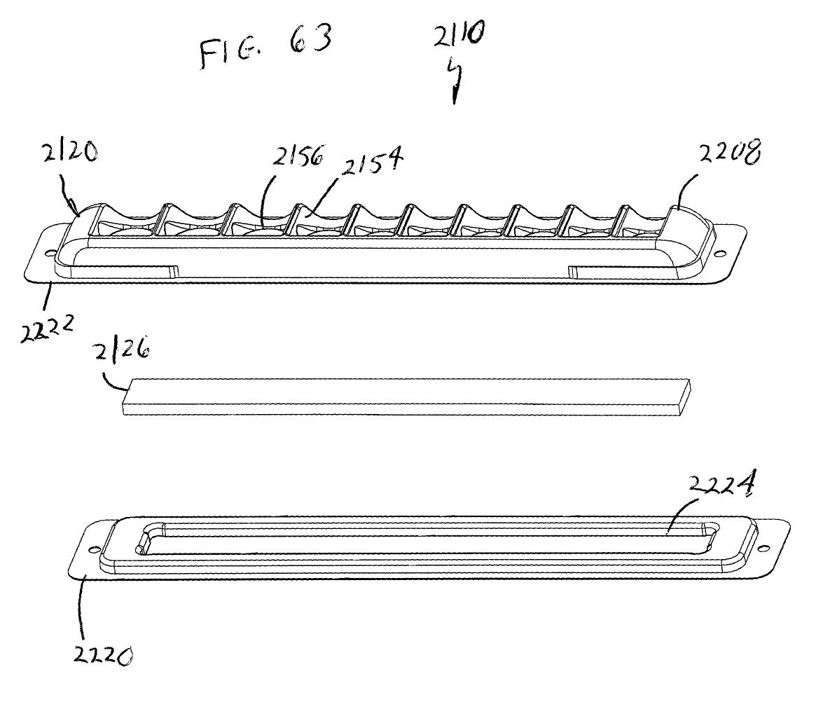

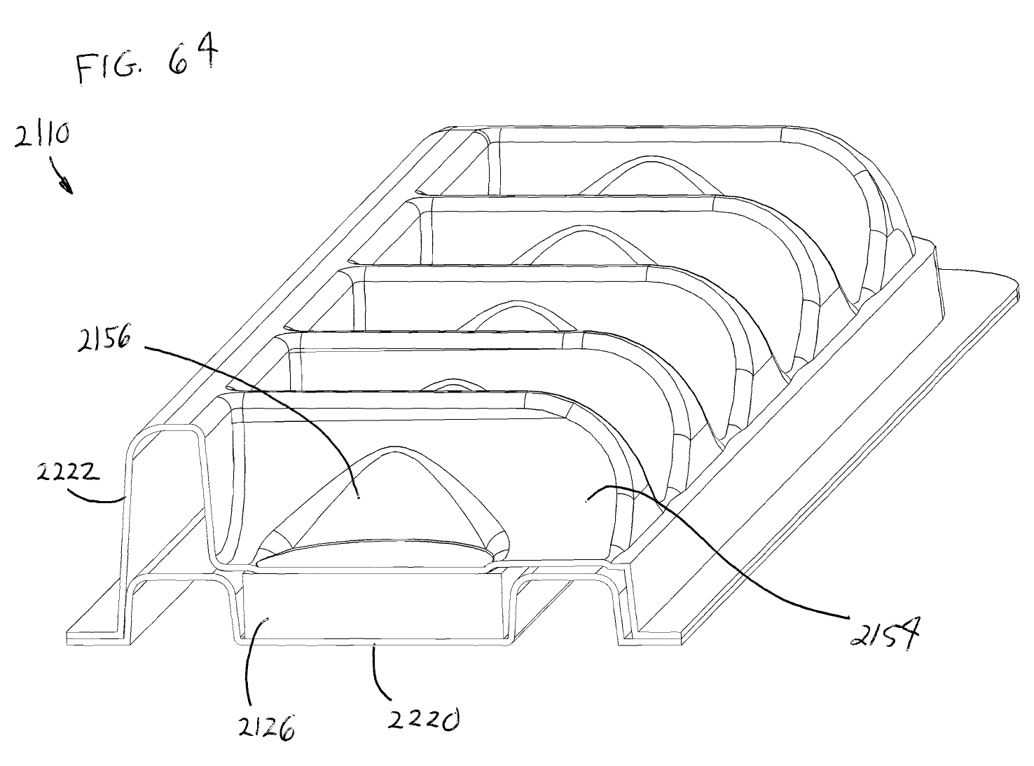

FIGS. 58-64 illustrate magnetic storage device 2110. Magnetic storage device 2110 comprises back 2120 and magnet 2126 (shown in FIG. 63). In the example illustrated, back 2120 comprises a two-piece assembly including a base 2220 and a tray 2222, wherein the base and tray are welded, fastened, snapped or otherwise joined to one another with magnet 2126 therebetween. In another implementation, back 2120 may comprise a body having an opening into which magnet 2126 is inserted. In the example illustrated, base 2220 includes a recess or channel 2224 (shown in FIG. 63) which receives and retains in place magnet 2126. In other implementations, magnetic storage device 2110 may omit base 2220, wherein magnet 2126 is otherwise adhered to tray 2222.

Tray 2222 has a front face 2208 into which are formed openings 2154 and 2156. Openings 2154 each comprises a semi-cylindrical opening extending into back 2120 in front of an overlying magnet 2126 and opening 2156. Opening 2154 is centered along (the central axis of the semi-cylindrical opening) axis 2160 (shown in FIG. 60). Opening 2154 facilitates reception of a cylindrical article such as a whole so, socket, container or the like, with the centerline of the article extending parallel or coincident with axis 2160. In the example illustrated, opening 2154 is blind in that opening 2154 terminates at a lower ledge 2164 to assist in supporting the received article. In other implementations, opening 154 may comprise a passage completely extending vertically across back 2120, allowing the article to project beyond the bottom of back 2120 when in the vertical orientation similar to that shown in FIG. 36.

Opening 2156 comprises a cylindrical opening projecting into back 2120 in front of magnet 2126. Opening 2156 extends through the back or floor of opening 2154. Opening 2156 is centered along an axis 2170 which is perpendicular to face 2208 and perpendicular to axis 2160. Opening 2156 is configured to receive an axial end of an article such as article 712 shown in FIGS. 36 and 37. Opening 2156 facilitates retention of the article with the article projecting outward and orthogonal from back 2120. Magnet 2126 assists in retaining the article to inhibit accidental dislodgment of the article.

Openings 2154 and 2156 allow the article to be selectively stored in either the vertical orientation shown or the horizontal orientation. Openings 154 and 2156 allow such a choice without increasing the overall footprint of the associated storage receptacle provided on tray 2222. In one implementation openings 2154, 2156 are illustrated as being configured to receive a cylindrical object in the form of the container 712. In other implementations openings 2154, 2156 may be configured to receive other cylindrical objects or articles such as hole saws, drill bits, sockets and the like.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A magnetic storage device for a article having a magnetic affinity, the magnetic storage device comprising:
a back having a first side with a face facing in a horizontal direction;
a protuberance extending from the face to engage a portion of the article; and
a magnet on a second side of the back, wherein the protuberance is configured to hold the article such that the article is free to rotate about an axis parallel to the face but for resistance against such rotation provided by the magnet.

2. The magnetic storage device of claim 1, wherein the protuberance comprises a post configured to hang the article.

3. The magnetic storage device of claim 1 further comprising a second protuberance, wherein the first protuberance and the second protuberance are spaced by recess configured to receive the article such that the article hangs from the first protuberance and the second protuberance.

4. The magnetic storage device of claim 1, wherein the protuberance comprises a ledge configured to underlie and support the article.

5. The magnetic storage device of claim 4 further comprising a second protuberance above the first protuberance, wherein the first protuberance and the second protuberance are spaced by recess configured to receive the article and wherein the article extends horizontally beyond the first protuberance and the second protuberance.

6. The magnetic storage device of claim 1 further comprising:
a second protuberance extending from the face and spaced from the protuberance to engage the article; and
a third protuberance extending from the face in space from the protuberance and the second protuberance to engage the article, the protuberance, the second protuberance in the third protuberance being sufficiently spaced to permit an article to rotate about the axis parallel to the face but for resistance against such rotation provided by the magnet.

7. The magnetic storage device of claim 1, wherein the protuberance is configured to engage the article on a first side of a center of mass of the article while the article is held by the storage device and wherein the magnet extends on a second side of the center of mass of the article while the article is held by the storage device.

8. The magnetic storage device of claim 1, wherein the protuberance cooperates with the face to form a cavity between the protuberance in the face, the cavity being configured to receive a first end of the article and wherein the magnet extends proximate a second end of the article opposite the first end.

9. The magnetic storage device of claim 8 further comprising a second protuberance configured to underlie the second end of the article while the first end of the article is received by the cavity.

10. The magnetic storage device of claim 1, wherein the back comprises a base having a cavity behind the face and facing the face, wherein the magnet is received within the cavity.

11. The magnetic storage device of claim 1 comprising a second protuberance, extending from the face and configured to engage a portion of a second article having a magnetic affinity, wherein the magnet extends across the first protuberance and the second protuberance.

12. A magnetic storage device for an article having a magnetic affinity, storage device comprising:
a back having a first side with a face facing in a horizontal direction;
a protuberance extending from the face to engage a portion of the article; and
a magnet on a second side of the back, wherein the protuberance cooperates with the face to form a cavity between the protuberance and the face, the cavity being configured to receive a first end of the article, wherein the magnet extends proximate a second end of the article opposite the first end.

13. The magnetic storage device of claim 12, wherein the cavity faces in an upward direction.

14. A magnetic storage device for an article having a magnetic affinity, the magnetic storage device comprising:
a back;
a protuberance forming an asymmetric opening from which the article may hang when the article is in a first orientation with respect to a vertical axis and through which the article may be withdrawn from the protuberance when the article is in a second orientation with respect to the vertical axis;
a magnet to bias the article towards the first orientation.

15. A magnetic storage device for an article having a magnetic affinity, the magnetic storage device comprising:
a back;
a first cylindrical opening on a first side of the back and centered along a first axis;
a first semi cylindrical opening overlying the first cylindrical opening on the first side of the back and centered along a second axis perpendicular to the first axis; and
a magnet on a second side of the back.

16. The magnetic storage device of claim 15 further comprising:
a second cylindrical opening on the first side of the back and centered along a first axis; and
a second semi cylindrical opening overlying the second cylindrical opening on the first side of the back and centered along a second axis perpendicular to the first axis, wherein the magnet extends across the first cylindrical opening and the second cylindrical opening.

17. The magnetic storage device of claim 15, wherein the first semi cylindrical opening and the second semi cylindrical opening are arranged in a row extending along a third axis perpendicular to the first axis and perpendicular to the second axis.

18. A magnetic storage device for a plurality of articles having a thickness and a magnetic affinity, the magnetic storage device comprising:
a base having an upper surface and a cavity formed in the upper surface;
a tray having an upper surface, a lower surface and the height there between, the lower service being sized configured to mate with the upper surface of this the base, the tray having a plurality of cavities formed in the upper surface, each of the cavity being sized configured to receive one of the plurality of articles, each of the cavities having an elongated, semicircular configuration with opposite ends, a pair of raised abutments aligned adjacent to the opposite ends of each of the cavities, each of the raised abutments having an upper surface which is located below the upper surface of the tray and each of the upper surfaces of the pair of raised abutments extending upward to a height that is less than the thickness of one of the plurality of articles when at least one of the plurality of articles that position in one of the cavities; and
a magnetic member positioned within the cavity of the base, the magnetic member exerting a sufficient magnetic attraction on the plurality of articles when each is positioned in one of the cavities temporally retain the plurality of articles therein, and the magnetic members exerting a sufficient magnetic attraction through the base to releasably attach the magnetic storage device to a magnetically attractive surface.

19. The magnetic storage device of claim 18 further comprising a cover having an upper surface, a lower surface and a hollow cavity which is open to the lower surface of the cover, and the hollow cavity being sized configured to fit over the tray.

20. A magnetic storage device for first articles having a magnetic affinity and a second article, magnetic storage device comprising:
a back;
at least one recess on a first side of the back and configured to receive the first articles;
a magnet on a second side of the back across each of the plurality of article receiving recesses;
a cavity in the back to receive the second article, the cavity being spaced from the plurality of article receiving recesses;
a cover pivotably connected to the back, the cover being pivotable between a first position in which the cover covers the cavity of the cavity receive the second article and a second position in which the cover is inverted to form a trough below the cavity when the back extends in a vertical plane.

21. The magnetic storage device of claim 20 further comprising a second cover releasably attached to the back and extending over the at least one recess, the cavity and the cover.

22. The magnetic storage device of claim 20, wherein the at least one recess comprises a plurality of recesses, each recess receiving one of the first articles.
